(19) United States
(12) Patent Application Publication
(10) Pub. No.: US 2011/0190115 A1
(43) Pub. Date: Aug. 4, 2011

(54) METAL-CONTAINING ORGANOSILICA CATALYST; PROCESS OF PREPARATION AND USE THEREOF

(76) Inventors: Rosaria Ciriminna, Palermo (IT); Mario Pagliaro, Palermo (IT); Giovanni Palmisano, Palermo (IT); Valerica Pandarus, Quebec City (CA); Lynda Tremblay, Quebec City (CA); Francois Béland, L'Ancienne-Lorette (CA); Mathieu Simard, Quebec City (CA)

(21) Appl. No.: 13/057,521

(22) PCT Filed: Aug. 4, 2009
(86) PCT No.: PCT/CA09/01098

§ 371 Date: Apr. 18, 2011

(30) Foreign Application Priority Data
Aug. 4, 2008 (US) 61/086022

(51) Int. Cl. B01J 21/06; B01J 31/28; B01J 31/32; B01J 31/34; B01J 31/36; B01J 31/38

(52) U.S. Cl. 502/158

(57) ABSTRACT

The invention relates to a metal-containing organosilica catalyst, and use thereof in metal-catalyzed reactions. The invention relates to a process of preparation of the metal-containing organosilica catalyst comprising i) mixing a silicon source with an hydrolytic solvent; ii) adding one or more metal catalyst or a precursor thereof; iii) treating the mixture of step ii) with a condensation catalyst and iv) optionally treating the mixture resulting from step iii) with one or more reducing or oxydating agent such as to provide the required oxidation level to the metal catalyst.

### CROSS REFERENCE TO RELATED APPLICATION

This application claims priority of U.S. provisional application 61/086,022 which is hereby incorporated by reference.

### FIELD OF THE DISCLOSURE

The invention generally relates to a metal-containing organosilica catalyst, its process of preparation and use thereof in metal-catalyzed reactions.

### BACKGROUND

Metal-containing catalytic reactions are important research and industrial tools. Unlike other reagents that participate in chemical reactions, metal catalysts are generally not consumed. Therefore, a catalyst has the ability to participate in many catalytic cycles.

Metal-containing catalysis is preferred in “green chemistry” compared to stoichiometric chemistry and can also leave access to reactions which are difficult or impossible to carry otherwise. For example, palladium-catalyzed cross-coupling reactions are one of the most powerful methods for constructing carbon-carbon, carbon-nitrogen, carbon-oxygen, and carbon-silicon bonds. Palladium and other transition metals are commonly used to catalyze redox processes. Platinum, palladium, and rhodium are used for example in hydrogenation reactions.

Metal-containing catalytic reactions, in particular homogeneous reactions such as palladium cross-coupling reactions, may have several shortcomings such as limited reusability which impacts cost, and metal contamination of the product. Removing residual metals in the reaction product may represent a challenging task.

### SUMMARY OF THE DISCLOSURE

In one aspect, there is provided a metal-containing organosilica catalyst.

In one aspect, there is provided a metal-containing organosilica catalyst obtainable by a process as described herein.

In a further aspect, there is also provided a process for preparing a metal-containing organosilica catalyst comprising i) mixing a silicon source with an hydrolytic solvent; ii) adding one or more metal catalyst or a precursor thereof; iii) treating the mixture of step ii) with a condensation catalyst and iv) optionally treating the mixture resulting from step iii) with one or more reducing or oxydizing agent such as to provide the required oxidation level to the metal catalyst.

In one aspect, the present invention relates to the use of a metal-containing organosilica catalyst as defined herein for conducting a metal-catalyzed reaction.

In one aspect, the present invention relates to a heterogeneous catalyst comprising a metal-containing organosilica catalyst as described herein.

In one aspect, there is provided a method for conducting a catalytic reaction comprising providing a metal-containing organosilica catalyst as described herein, providing at least one reactant capable of entering into said catalytic reaction, allowing said at least one reactant to diffuse and adsorb onto the metal of said metal-containing organosilica catalyst and allowing a product resulting from said catalytic reaction to desorbs from the metal and diffuse away from the solid surface to regenerate a catalytic site onto the metal of said metal-containing organosilica catalyst.

### DETAILED DESCRIPTION

The expression “silicon source” as used herein, refers to a compound of formula R₄₋ₓSi(L)ₓ wherein R is an alkyl, an aryl or an alkyl-aryl such as a benzyl, L is independently Cl, Br, I or OR′ wherein R′ is an alkyl or benzyl and x is an integer of 1 to 4 or alternatively x is an integer of 1 to 3. The “silicon source” is selected so as to be able to form a network of Si—O—Si bonds. The “silicon source” is understood to include one or more of said compound of formula R₄₋ₓSi(L)ₓ.

In one embodiment, the silicon source is a silicon alkoxide such as monoalkyl-trialkoxy silane, or a dialkyl-dialkoxy silane. In a further embodiment, the silicon alkoxide is a mixture of monoalkyl-trialkoxy silane, and dialkyl-dialkoxy silane. In a further embodiment, the mixture of monoalkyl-trialkoxy silane and dialkyl-dialkoxy silane is further comprising trialkyl-alkoxy silane and/or tetraalkoxy silane.

In one embodiment, the silicon source is a silicon alkoxide that is tetraalkoxy silane. In one embodiment, the silicon source is a mixture of silicon alkoxide comprising two or more of monoalkyl-trialkoxy silane, dialkyl-dialkoxy silane, trialkyl-alkoxy silane and tetraalkoxy silane.

In further embodiments, the alkyl and alkoxy residue of the silicon alkoxide are independently linear or branched and comprising 1 to 10 carbon atoms, alternatively 1 to 6 carbon atoms, alternatively 1 to 3 carbon atoms and alternatively 1 carbon atom.

In one embodiment, the silicon alkoxide is methyltriethoxy silane (MTES).

In one embodiment, the silicon alkoxide is tetramethoxy-ortho-silicate (TMOS).

In one embodiment, the silicon source is a mixture of methyltriethoxy silane and tetramethoxy-ortho-silicate.

In one embodiment, the silicon source is a silicon halide of formula RSiL₃ such as MeSiI₃, MeSiCl₃, MeSiBr₃, EtSiBr₃, EtSiCl₃, EtSiI₃.

The hydrolytic solvent for use in the present disclosure is a solvent or a mixture of solvents favoring formation of —Si—OH species from hydrolysis of the silicon source. Examples of such a solvent include aqueous solvents, such as a mixture of water and an inorganic acid such as HCl, H₃PO₄, H₂SO₄, HNO₃. When an acid such as HCl or HNO₃ is used, from about 10⁻⁴ to about 10⁻² mole equivalents of H⁺ can be used (based on the molar amount of the silicon alkoxide). Preferably, about 0.003 mole equivalents are used.

In one embodiment, the hydrolytic solvent is HCl(aq). In one embodiment, the hydrolytic solvent is HNO₃(aq).

The “metal”, in said metal-containing organosilica catalyst, can be any metal at any suitable oxidation level which can be incorporated in a silica network and is useful, in catalyzing a chemical reaction.

The “metal precursor” means any metal complex, a metal salt or their corresponding anhydrous or solvated forms that can provide the required catalytic activity either by itself or by reduction or oxidation to the appropriate oxidation level, or decomplexation of the ligands. Solvated metal precursor includes hydrated forms.

Examples of the metal in the metal-containing organosilica catalyst of this invention includes transition metals (i.e. those of the periodic table in columns IVB to IIB) such as Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd and Hg and metals of columns IIIa to VIa of the periodic table such as Al, Ga, In, Ti, Ge, Sn, Pb, Sb, Bi. In one embodiment, the metal includes without limitation Ni, Ru, Rh, Pt, Sn, Zr, In, Co, Cu, Cr, Mo, Os, Fe, Ag, Au, Ir and Pd, at any suitable oxidation level.

In one embodiment, the metal catalyst or a precursor thereof is a palladium compound. In one embodiment, the metal catalyst or a precursor thereof includes without limitation Pd(OAc)₂, K₂PdCl₄, (CF₃CO₂)₂Pd, M₂PdX₄ [M=Li, Na, K; X=Cl, Br], PdX₂Y₂ [X=Cl, Br, I; Y=O, CH₃CN, THF, PhCN], M₂PdCl₆ [M=Na, K]. Preferably the palladium compound is added as a solution. Typically about 0.001 to about 0.1 mole equivalents of the palladium compound can be used (based on the molar amount of the silicon alkoxide). Preferably, about 0.004 to about 0.018 mole equivalents are used.

In one embodiment, the metal catalyst or a precursor thereof is a platinum compound. In one embodiment, the metal catalyst or a precursor thereof includes without limitation PtCl₂ and Pt(acac)₂ [acac=acetylacetonate], M₂PtX₄ [M=Li, Na, K; X=Cl, Br] such as K₂PtCl₄, (NH₄)₂PtCl₄, H₂PtCl₆, Na₂PtCl₆, K₂PtCl₆, Li₂PtCl₆, PtCl₄, such as Pt(C₂H₄)₃, Pt(COD)₂, Pt(PPh₃)₄. Preferably the platinum compound is added as a solution. Typically about 0.001 to about 0.1 mole equivalents of the platinum compound can be used (based on the molar amount of the silicon alkoxide). Preferably, about 0.004 to about 0.018 mole equivalents are used.

In one embodiment, the metal catalyst or a precursor thereof is a rhodium compound. In one embodiment, the metal catalyst or a precursor thereof includes without limitation RhX₃ [X=Cl, Br] such as RhCl₃xH₂O, Rh₂O₃xH₂O, Rh(OAc)₃, rhodium(II) acetate dimer, Rh(NO₃)₃, Rh(acac)₃, RhCl(olefin)₂]₂; [RhCl(diolefin)₂]. Preferably the rhodium compound is added as a solution. Typically about 0.001 to about 0.1 mole equivalents of the rhodium compound can be used (based on the molar amount of the silicon alkoxide). Preferably, about 0.004 to about 0.018 mole equivalents are used.

In one embodiment, the metal catalyst or a precursor thereof is a nickel compound. In one embodiment, the metal catalyst or a precursor thereof includes without limitation NiX₂ [X=Cl, Br] such as NiCl₂, Ni(OAc)₂, Ni(NO₃)₂, Ni(acac)₂, Ni(OH)₂, NiSO₄, (Et₄N)₂NiCl₄. Preferably the nickel compound is added as a solution. Typically about 0.001 to about 0.1 mole equivalents of the nickel compound can be used (based on the molar amount of the silicon alkoxide). Preferably, about 0.01 to about 0.04 mole equivalents are used.

In one embodiment, the metal catalyst or a precursor thereof is a ruthenium compound. In one embodiment, the metal catalyst or a precursor thereof includes without limitation RuX₃ [X=Cl, Br, I] including RuCl₃, K₂RuCl₅, Ru(OAc)₃, Ru(acac)₃ or any Ru complex such as [RuCl₂(CO)₃]₂, RuCl₂(PPh₃)₃, CpRu(PPh₃)₂Cl. Preferably, the ruthenium compound is added as a solution. Typically about 0.001 to about 0.1 mole equivalents of the ruthenium compound can be used (based on the molar amount of the silicon alkoxide). Preferably, about 0.004 to about 0.009 mole equivalents are used.

In one embodiment, the metal catalyst or a precursor thereof is a copper compound. In one embodiment, the metal catalyst or a precursor thereof includes without limitation CuX [X=Cl, Br, I], Cu(OAc), CuX₂ [X=Cl, Br, I], Cu(OAc)₂, Cu(CF₃CO₂)₂, Cu(NO₃)₂, CuSO₄, Cu(acac)₂, CuCO₃ or any Cu complex such as CuNO₃(PPh₃)₂, CuBr(PPh₃)₃. Preferably, the copper compound is added as a solution. Typically about 0.001 to about 0.1 mole equivalents of the copper compound can be used (based on the molar amount of the silicon alkoxide). Preferably, about 0.004 to about 0.028 mole equivalents are used.

In one embodiment, the metal catalyst or a precursor thereof is an iron compound. In one embodiment, the metal catalyst or a precursor thereof includes without limitation FeX₂ [X=Cl, Br, I], FeSO₄, Fe(OAc)₂, Fe(acac)₂, FeX₃ [X=Cl, Br, I] such as FeCl₃, Fe₂(SO₄)₃, Fe(acac)₃, Fe(NO₃)₃, FePO₄ or any Fe complex such as (FeCp(CO)₂)₂. Preferably, the iron compound is added as a solution. Typically about 0.001 to about 0.1 mole equivalents of the iron compound can be used (based on the molar amount of the silicon alkoxide). Preferably, about 0.005 to about 0.01 mole equivalents are used.

In one embodiment, the metal catalyst or a precursor thereof is an iridium compound. In one embodiment, the metal catalyst or a precursor thereof includes without limitation IrX₃ [X=Cl, Br] such as IrCl₃, Ir(acac)₃. Preferably the iridium compound is added as a solution. Typically about 0.001 to about 0.1 mole equivalents of the iridium compound can be used (based on the molar amount of the silicon alkoxide). Preferably, about 0.005 to about 0.01 mole equivalents are used.

In one embodiment, the metal catalyst or a precursor thereof is a silver compound. In one embodiment, the metal catalyst or a precursor thereof includes without limitation AgX [X=Cl, Br], AgNO₃, AgNO₂, Ag₂SO₄. Preferably the silver compound is added as a solution. Typically about 0.001 to about 0.1 mole equivalents of the silver compound can be used (based on the molar amount of the silicon alkoxide). Preferably, about 0.01 to about 0.02 mole equivalents are used.

In one embodiment, the metal catalyst or a precursor thereof is a mixture of more than one of said metal catalyst or a precursor thereof. In one embodiment, the mixture is comprising two or more metal catalysts or a precursor thereof, comprising Ni, Ru, Rh, Pt, Sn, Zr, In, Co, Cu, Cr, Mo, Fe, Ag, Au, Ir, Os, or Pd.

In further embodiments, the mixture of said metal catalyst or a precursor thereof is a combination comprising: Pt/Pd, Pt/Rh, Pt/Ir, Pt/Ni, Pt/Co, Pt/Cu, Pt/Ru, Pt/Ag, Pt/Au, Pd/Ag, Pd/Au, Rh/Ir, Rh/Ru, Ru/Ir, Ru/Fe, Ni/Co or Rh/Pd. Preferably the mixture of said metal catalyst or a precursor thereof is comprising Rh/Pd, Pt/Ni, Pt/Pd or Rh/Pt.

As used herein, “Condensation catalysts” means any reagent known in the art favoring the polycondensation to form the —Si—O—Si— bonds.

Condensation catalysts can be for example NaOH, HCl, KOH, LiOH, NH₄OH, Ca(OH)₂, NaF, KF, TBAF, TBAOH, TMAOH. Typically about 0.01 to about 0.1 mole equivalents of the condensation catalyst, such as NaOH, can be used (based on the molar amount of the silicon alkoxide). Preferably, about 0.023 to about 0.099 mole equivalents are used.

In one embodiment, the condensation catalyst is NaOH.

In accordance with the disclosure, reducing agent includes hydride-based reducing agents. In one embodiment, the reducing agent is (CH₃CO₂)₃BHM [M: Na, K, N(CH₃)₄], MBH₄ [M: Na, K, Li], M-triethylborohydride (M=Li, K, Na) solution, MBH₃CN (M: Na, Li, K, N(CH₃)₄, N(Bu)₄), LiAlH₄, R₄N(BH₄) (R: Me, Et, Bu), DIBAL, X-Selectride (X=N, K, KPh₃BH, M(C₂H₃)₃BH (M: Li, Na, K), (CH₃)₂NBH₃Li, NaB(OCH₃)₃H or a combination thereof. Typically 1:2 to about 1:20 equivalents (metal:reducing agent) or about 1:2 to about 1:8 mole equivalents of the reducing agent can be used based on the molar amount of the metal to be reduced (e.g. based on the molar amount of the compound).

In one embodiment, the reducing agent is sodium triacetoxyborohydride and/or sodium borohydride.

When reference is made to “incorporation of a metal catalyst or a precursor thereof into a network of Si—O—Si bonds” it is understood that such incorporation means that said metal catalyst or a precursor is prevented from being removable of said metal-containing organosilica catalyst in the reaction medium or by washing off the catalyst with any conventional organic or aqueous solvent. Without being bound to theory, it is believed that the metal catalyst or a precursor is incorporated and retained in the organosilica matrix by encapsulation.

In one embodiment, there is provided a metal-containing organosilica catalyst.

In one embodiment, there is also provided a process for preparing a metal-containing organosilica catalyst comprising i) mixing a silicon source selected from monoalkyl-trialkoxy silane, tetraalkoxy silane and mixtures thereof with an hydrolytic solvent; ii) adding one or more metal catalyst or a precursor thereof, wherein said metal or precursor thereof is comprising Ni, Ru, Rh, Pt, Sn, Zr, In, Co, Cu, Cr, Mo, Fe, Ag, Au, Ir, Os or Pd; iii) treating the mixture of step ii) with a condensation catalyst and iv) optionally treating the mixture resulting from step iii) with one or more reducing or oxidizing agent such as to provide the required oxidation level to the metal catalyst.

In one embodiment, said step ii) is comprising adding one metal catalyst or a precursor thereof.

In one embodiment, said step ii) is comprising adding two metal catalysts or a precursor thereof.

In one embodiment, there is provided a process for preparing a metal-containing organosilica catalyst comprising i) mixing a silicon source with an hydrolytic solvent; ii) adding a metal compound; iii) treating the mixture of step ii) with a condensation catalyst and iv) optionally treating the mixture resulting from step iii) with a one or more agent such as to provide the required oxidation level to the metal.

In one embodiment, step i) in any of the embodiments in accordance with the invention further optionally comprises applying vacuum, or heat, or both to remove volatile products resulting from said step i).

In one embodiment, the present invention relates to the use of a metal-containing organosilica catalyst as defined herein for conducting a metal-catalyzed reaction including hydrogenation of aromatic rings, carbocycles and heterocycles; hydrogenation of carbonyl compounds; hydrogenation of nitro and nitroso compounds; hydrogenation of halonitroaromatics; reductive alkylation; hydrogenation of nitriles; hydrosilylation; selective oxidation of primary alcohols to the aldehyde; selective oxidation of primary alcohols and aldehydes to the carboxylic acid, hydrogenation of carbon-carbon multiple bond; hydrogenation of oximes; hydroformylation; carbonylation; formation of carbon-carbon, carbon-oxygen and/or carbon-nitrogen bond; hydrogenolysis; dehydrogenation; hydrogenation of glucose; synthesis of oxygen-containing compounds bond.

In one embodiment, the present invention relates to the use of a metal-containing organosilica catalyst to conduct a catalytic reaction such as to create a carbon-carbon bond, carbon-nitrogen bond, carbon-oxygen bond, and conduct reduction (hydrogenation, hydrogenolysis) or oxidation. In one embodiment, the present invention relates to the use of a metal-containing organosilica catalyst to create a carbon-carbon bond.

Examples of carbon-carbon bond forming reactions using a metal-containing organosilica catalyst of the disclosure include reactions known as Heck, Suzuki, Sonogashira, Stille, Negishi, Kumada, Hiyama, and Fukuyama. Examples of carbon-nitrogen bond forming reactions using metal-containing organosilica catalyst of the disclosure include reactions known as Buchwald-Hartwig amination, hydroamination.

The metal-containing organosilica catalyst has characteristics that allow for performing reactions that can normally be performed in a homogeneous phase. The catalyst typically has a metal loading of between about 0.01 to about 1.00 mmoles per gram of catalyst and alternatively about 0.025 to about 0.52 mmoles per gram of catalyst. The specific surface can vary from about 50 to about 1500 m²/g of catalyst and alternatively from about 200 to 1000 m²/g of catalyst.

The metal-containing organosilica catalyst defined herein can be used on its own or be part of a catalytic device or other supporting material.

The characteristics (described as typical, preferred and/or alternate) mentioned in the disclosure with regard to the process, method, catalyst or use can be combined or interverted freely. For example, a typical palladium salt (such as any salt of Pd mentioned above) can be used in a preferred amount (such as about 0.004 to about 0.018 mole equivalents) with a typical amount of the condensation catalyst (such as about 0.002 to about 0.12 mole equivalents) together with a preferred amount of reducing agent. Although all such combinations are not specifically nor literally recited, they are considered to be directly and unambiguously disclosed herein.

### Example 1

### Preparation of Palladium-Containing Organosilica Catalyst

A mixture of MTES (27 g, 30 mL, 151.4 mmol) and 10 mL of 0.042 M HCl(aq) (0.42 mmol H+ and 555 mmol H₂O) is stirred vigorously for 15 minutes (or until the solution is homogeneous). The resulting solution is concentrated on rotavapor at 30° C. under reduced pressure until complete ethanol removal (with completeness being ensured by weighing). The resulting hydrogel is doped by addition of a solution of K₂PdCl₄ (from 0.004 to 0.018 equiv) dissolved in distilled and deionized water for better solubility and 60 mL acetonitrile. To this mixture is added NaOH(aq) 1M (from 0.023 to 0.053 equiv) to favor the gelation process. The resulting homogeneous and clear gel is left open to dry at ambient temperature for about 4 days. The xerogel thereby obtained is then reduced at room temperature with a solution of sodium triacetoxyborohydride in THF (Pd:Na(AcO)₃BH=1:6 molar ratio; 80 mL), washed with THF and H₂O and left open to dry at room temperature. The resulting catalysts are reported in Table 1 as entries Si—Pd-1 to Si—Pd-4.

TABLE 1

| | | | Pore | Pore | MTES:K₂PdCl₄:H⁺: |
|---|---|---|---|---|---|
| | Loading | Surface | Size | Volume | H₂Oₜₒₜₐₗ:NaOH |
| Entry | (mmol/g) | (m²/g) | (Å) | (cm³/g) | (equiv) |
| Si-0-A | 0.00 | 591 | 46 | 0.68 | 1:0.000:0.003: |
| | | | | | 4.89:0.023 |
| Si—Pd-1 | 0.025 | 754 | 40 | 0.81 | 1:0.004:0.003: |
| | | | | | 6.72:0.023 |
| Si—Pd-2 | 0.112 | 774 | 45 | 0.83 | 1:0.009:0.003: |
| | | | | | 7.62:0.033 |
| Si—Pd-3 | 0.148 | 724 | 49 | 0.82 | 1:0.013:0.003: |
| | | | | | 8.51:0.043 |
| Si—Pd-4 | 0.163 | 721 | 53 | 0.86 | 1:0.018:0.003: |
| | | | | | 10.14:0.053 |

### Sample Characterization

Nitrogen adsorption and desorption isotherms at 77 K are measured using a Micrometrics TriStar™ 3000 system. The data are analysed using the Tristar™ 3000 model 4.01. Both adsorption and desorption branches are used to calculate the pore size distribution.

The metal content in the products is measured using the CAMECA SX100 instrument equipped with EPMA analyse technique, a fully qualitative and quantitative method of non-destructive elemental analysis of micron-sized volumes at the surface of materials, with sensitivity at the level of ppm.

The absorption IR spectrum of entry Si—Pd-4 described in table 1 is obtained at room temperature using an ABB Bomem MB series FTIR spectrometer at a resolution of cm⁻¹ and taking 30 scans per spectrum in the range of 4000-500 cm⁻¹. The dominant peaks characteristic of the bond Si—O are assigned, according to the literature (see Galeener, E G., Phys. Rev. B 1979, 19, 4292 and Park, E. S.; Ro, H. W.; Nguyen, C. V.; Jaffe, R. L.; Yoon, D. Y. Chem. Mater 2008, 20(4), 1548) as follows: the main higher frequency band at about 1023 cm⁻¹ is ascribed to the symmetric stretching of the oxygen atoms accompanied by the band at about 1116 cm⁻¹ ascribed to the asymmetric stretching of the oxygen atoms; the band at frequency near 771 cm⁻¹ is due to the symmetric stretching motion of oxygen atoms; the lower frequency peak at 550 cm⁻¹ can be attributed to rocking motions of the oxygen atoms perpendicular to the Si—O—Si. Methyl groups attached to Si atoms have a characteristic and very sharp band at 1270 cm⁻¹ due to the symmetric deformation vibration of the CH₃ group, and at 2978 cm⁻¹ due to stretching vibration of C—H bonds (see Galeener, E G. Phys. Rev. B 1979, 19, 4292 and Brown, J. F., Jr.; Vogt, L. H., Jr.; Prescott, P. I. J. Am. Chem. Soc. 1964, 86, 1120).

### Example 2

### Palladium-Containing Organosilica Catalytic Reactions—Suzuki Coupling

A mixture of the desired haloarene, the phenylboronic acid and the potassium carbonate K₂CO₃ in methanol, 1-butanol or ethanol is refluxed for 15 minutes or more until it became homogeneous. The catalysts described in example 1 are added with respect to the substrate. After completion of the reaction (monitored by TLC and GC/MS) the catalyst is filtered, the solvent is evaporated and the residue is treated with ethyl acetate. The solution is filtered and the evaporation of the solvent gave the coupling product, purified by flash chromatography (eluent used is 5:1 hexanes-acetone). The results are summarized in Table 2.

TABLE 2
Suzuki coupling reaction

| | | mol % | PhB(OH)₂ | K₂CO₃ | | | | ^{b}Conv./ |
|---|---|---|---|---|---|---|---|---|
| Entry | Ph—X | ^{a}Catalyst | (equiv) | (equiv) | Solvent | Time | | Yield (%) |
| 2-1 | 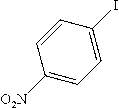 | 0.1 mol % Si—Pd-1 | 1.79 | 3.72 | MeOH (0.07 M) | 15 | min | 100 |
| 2-2 | 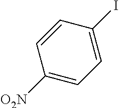 | 0.1 mol % Si—Pd-2 | 1.79 | 3.72 | MeOH (0.07 M) | 15 | min | 100 |
| 2-3 | 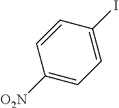 | 0.1 mol % Si—Pd-3 | 1.79 | 3.72 | MeOH (0.07 M) | 15 | min | 100 |
| 2-4 | 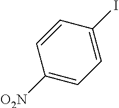 | 0.1 mol % Si—Pd-4 | 1.79 | 3.72 | MeOH (0.07 M) | 15 | min | 100 |
| 2-5 | 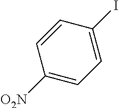 | 0.01 mol % Si—Pd-1 | 1.79 | 3.72 | MeOH (0.04 M) | 2 | h | 100/98.5 |
| 2-6 | 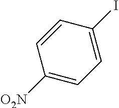 | 1 mol % Si—Pd-1 | 1.1 | 2 | MeOH (0.08 M) | 5 | min | 100 |
| 2-7 | 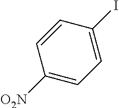 | 0.5 mol % Si—Pd-1 | 1.1 | 2 | MeOH (0.08 M) | 5 | min | 100 |
| 2-8 | 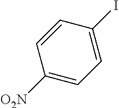 | 0.1 mol % Si—Pd-1 | 1.1 | 2 | MeOH (0.08 M) | 30 | min | 100 |
| 2-9 | 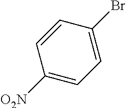 | 0.2 mol % Si—Pd-2 | 1.13 | 2 | MeOH (0.1 M) | 2 | h | 100 |
| 2-10 | 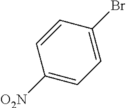 | 0.02 mol % Si—Pd-1 | 1.13 | 2 | MeOH (0.13 M) | 30 | min | 100/98.7 |
| 2-11 | 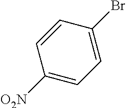 | 0.01 mol % Si—Pd-1 | 1.13 | 2 | MeOH (0.14 M) | 30 | min | 100/98 |
| 2-12 | 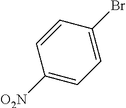 | 0.5 mol % Si—Pd-2 | 1.1 | 2 | EtOH (0.08 M) | 4 | h | 100 |
| 2-13 | 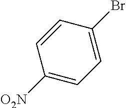 | 0.5 mol % Si—Pd-2 | 1.1 | 2 | EtOH (0.1 M) | 2 | h | 100 |
| 2-14 | 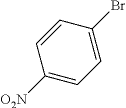 | 0.1 mol % Si—Pd-2 | 1.13 | 2 | EtOH (0.125 M) | 3 | h | 100 |
| 2-15 | 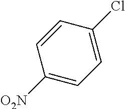 | 1 mol % Si—Pd-1 | 1.79 | 3.72 | 1-Butanol (0.04 M | 20 | h | 95/75^{c} |

^{a}: Catalysts identified in Table 1.
^{b}: The conversion with respect to the substrate is determined by GC/MS analysis. The yields are determined by isolation of the product via flash chromatography.
^{c}: The formation of the biphenyl Ph—Ph product is observed.

### Example 3

### Palladium-Containing Organosilica Catalytic Reactions—Sonogashira Coupling

A mixture of the 4-iodo-nitrobenzene (237 mg, 0.952 mmol, 1 equiv), the phenylacetylene (102 mg, 0.997 mmol, 1.05 equiv) and the potassium carbonate (420 mg, 3.04 mmol, 3.2 equiv) in 40 mL EtOH/H₂O is refluxed for 15 minutes or more until it became homogeneous. The catalysts described in example 1 are added with respect to the substrate. After completion of the reaction (monitored by TLC and GC/MS) the catalyst is filtered, the solvent is evaporated and the residue is treated with ethyl acetate. The solution is filtered and the evaporation of the solvent gave the coupling product. The results are summarized in Table 3.

TABLE 3
Sonogashira coupling reaction

| | | mol % | Ph—C≡C | K₂CO₃ | | Time | ^{b}Conv. |
|---|---|---|---|---|---|---|---|
| Entry | Ph—X | ^{a}Catalyst | (equiv) | (equiv) | Solvent | (h) | (%) |
| 3-1 | 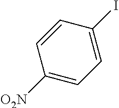 | 0.1 mol % Si—Pd-1 | 1.05 | 3.2 | EtOH/H₂O | 0.25 | 100 |
| 3-2 | 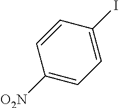 | 0.1 mol % Si—Pd-2 | 1.05 | 3.2 | EtOH/H₂O | 24 | 100 |
| 3-3 | 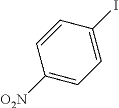 | 0.1 mol % Si—Pd-3 | 1.05 | 3.2 | EtOH/H₂O | 24 | 100 |
| 3-4 | 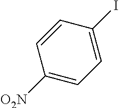 | 0.1 mol % Si—Pd-4 | 1.05 | 3.2 | EtOH/H₂O | 24 | 100 |

^{a}: Catalysts identified in Table 1.
^{b}: The conversion with respect to the substrate is determined by GC/MS analysis.

### Example 4

### Preparation of Methyltriethoxysilane-Based Xerogel

A mixture of MTES (27 g, 30 mL, 151.4 mmol) and 10 mL of 0.042 M HCl(aq) (0.42 mmol H+ and 555 mmol H₂O) is stirred vigorously for 15 minutes (or until the solution is homogeneous). The resulting solution is concentrated on rotavapor at 30° C. under reduced pressure until complete ethanol removal (with completeness being ensured by weighing) and 60 mL acetonitrile is added. To favor the gelation process 3.5 mL (0.023 equiv) NaOH(aq) 1M is added. The resulting homogeneous and clear gel is left open to dry at ambient temperature for about 4 days. The xerogel thereby obtained is washed with H₂O, MeOH and THF and left open to dry at room temperature. The resulting methyltriethoxysilane-based xerogel is reported as entry Si—O-A. (reference material).

### Example 5

### Preparation of Platinum-Containing Organosilica Catalyst

A mixture of MTES (27 g, 30 mL, 151.4 mmol) and 10 mL of 0.042 M HCl(aq) (0.42 mmol H+ and 555 mmol H₂O) is stirred vigorously for 15 minutes (or until the solution is homogeneous). The resulting solution is concentrated on rotavapor at 30° C. under reduced pressure until complete ethanol removal (with completeness being ensured by weighing). The resulting hydrogel is doped by addition of a solution of K₂PtCl₄ (from 0.004 to 0.018 equiv) dissolved in distilled and deionized water (for better solubility) and 60 mL acetonitrile. To this mixture is added NaOH(aq) 1M (from 0.023 to 0.053 equiv) to favor the gelation process. The resulting homogeneous and clear gel is left open to dry at ambient temperature for about 4 days. The xerogel thereby obtained is then reduced at room temperature with a solution of sodium borohydride in THF:H₂O=1:1 (Pt:NaBH₄=1:12 molar ratio; 180 mL), washed with H₂O and THF and left open to dry at room temperature. The resulting catalysts are reported in Table 4 as entries Si—Pt-1 to Si—Pt-3.

### Example 6

### Platinum-Containing Organosilica Catalytic Reactions—Hydrogenation of Aryl Nitro Groups in the Presence of Halides

The nitro substrate (2 mmol, 1 equiv) and Si—Pt catalyst prepared in example 5 (from 5 to 0.1 mol %) are combined in methanol (10 mL) and stirred under a hydrogen atmosphere (1 atm) at room temperature until GC/MS analysis indicated maximum conversion. Table 5 is summarizing the results obtained.

### Example 7

### Platinum-Containing Organosilica Catalytic Reactions—Hydrogenation of Arenes

The substrate (2 mmol, 1 equiv) and Si—Pt catalyst prepared in example 5 (from 1 to 2.5 mol %) are combined in methanol (10 mL) and stirred under a hydrogen atmosphere (1 atm) at room temperature. The conversion with respect to the substrate is determined by GC/MS analysis. Table 6 is summarizing the results obtained.

TABLE 4

| | | | Pore | Pore | MTES:K₂PtCl₄:H⁺: |
|---|---|---|---|---|---|
| | Loading | Surface | Size | Volume | H₂Oₜₒₜₐₗ:NaOH |
| Entry | (mmol/g) | (m²/g) | (Å) | (cm³/g) | (equiv) |
| Si-0-A | 0.00 | 591 | 46 | 0.68 | 1:0.000:0.003: |
| | | | | | 4.89:0.023 |
| Si—Pt-1 | 0.05 | 688 | 42 | 0.72 | 1:0.004:0.003: |
| | | | | | 8.56:0.023 |
| Si—Pt-2 | 0.11 | 597 | 56 | 0.84 | 1:0.009:0.003: |
| | | | | | 9.45:0.033 |
| Si—Pt-3 | 0.19 | 502 | 60 | 0.88 | 1:0.018:0.003: |
| | | | | | 11.97:0.053 |

TABLE 5

| | | ^{a}Mol % | Time | | % Conversion^{b} | | |
|---|---|---|---|---|---|---|---|
| Entry | Substrate | Catalyst | (h) | Product | Product | Aniline | Other |
| 5-1 | 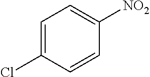 | 5 mol % Si—Pt-1 | 0.5 | 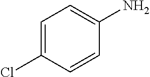 | 91 | 5 | 4 |
| 5-2 | 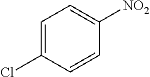 | 5 mol % Si—Pt-2 | 0.5 | 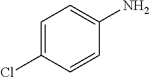 | 93 | 4 | 3 |
| 5-3 | 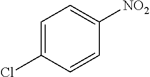 | 1 mol % Si—Pt-1 | 0.5 | 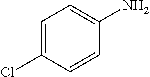 | 90 | 10 | 0 |
| 5-4 | 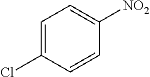 | 1 mol % Si—Pt-2 | 0.5 | 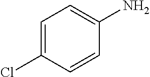 | 92 | 8 | 0 |
| 5-5 | 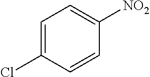 | 0.5 mol % Si—Pt-1 | 1 | 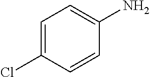 | 95 | 5 | 0 |
| 5-6 | 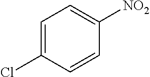 | 0.5 mol % Si—Pt-2 | 0.5 | 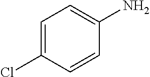 | 87 | 13 | 0 |
| 5-7 | 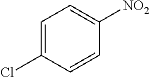 | 0.2 mol % Si—Pt-1 | 1 | 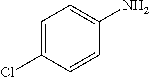 | 86 | 14 | 0 |
| 5-8 | 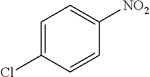 | 0.2 mol % Si—Pt-2 | 0.5 | 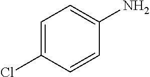 | 84 | 16 | 0 |
| 5-9 | 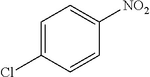 | 0.1 mol % Si—Pt-1 | 2 | 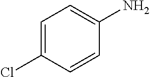 | 83 | 17 | 0 |
| 5-10 | 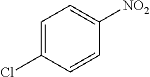 | 0.1 mol % Si—Pt-2 | 2 | 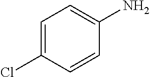 | 90 | 10 | 0 |
| 5-11 | 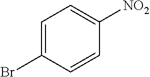 | 0.5 mol % Si—Pt-2 | 1 | 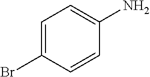 | 85 | 15 | 0 |
| 5-12 | 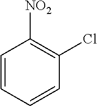 | 0.5 mol % Si—Pt-1 | 1.5 | 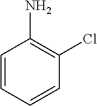 | 94 | 6 | 0 |
| 5-13 | 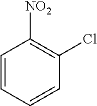 | 0.5 mol % Si—Pt-2 | 1 | 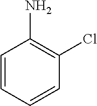 | 97 | 3 | 0 |

^{a}Mol % catalyst identified in Table 4 and used in reaction.
^{b}The conversion with respect to the substrate is determined by GC/MS analysis.

TABLE 6

| | | | | | % |
|---|---|---|---|---|---|
| En- | | ^{a}Mol % | Time | | Conversion^{b} |
| try | Substrate | Catalyst | (h) | Product | Product |
| 6-1 | 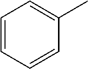 | 1 mol % Si—Pt-1 | 24 | 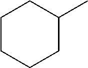 | 25 |
| 6-2 | 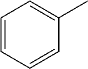 | 1 mol % Si—Pt-2 | 24 | 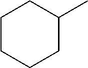 | 95 |
| 6-3 | 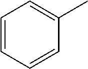 | 2.5 mol % Si—Pt-2 | 16 | 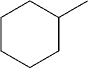 | 100 |
| 6-4 | 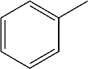 | 2.5 mol % Si—Pt-2 | 8 | 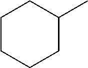 | 80 |
| 6-5 | 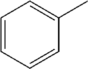 | 2.5 mol % Si—Pt-3 | 16 | 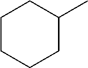 | 100 |
| 6-6 | 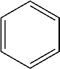 | 2.5 mol % Si—Pt-2 | 16 | 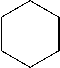 | 100 |

^{a}Mol % catalyst identified in Table 4 and used in reaction.
^{b}The conversion with respect to the substrate is determined by GC/MS analysis.

### Example 8

### Preparation of Rhodium-Containing Organosilica Catalyst

A mixture of MTES (27 g, 30 mL, 151.4 mmol) and 10 mL of 0.042 M HCl(aq) (0.42 mmol H+ and 555 mmol H₂O) is stirred vigorously for 15 minutes (or until the solution is homogeneous). The resulting solution is concentrated on rotavapor at 30° C. under reduced pressure until complete ethanol removal (with completeness being ensured by weighing). The resulting hydrogel is doped by addition of a solution of RhCl₃xH₂O (from 0.004 to 0.018 equiv) dissolved in distilled and deionized water (for better solubility) and 60 mL acetonitrile. To this mixture is added NaOH(aq) 1M (from 0.026 to 0.099 equiv) to favor the gelation process. The resulting homogeneous and clear gel is left open to dry at ambient temperature for about 4 days. The xerogel thereby obtained is then reduced at room temperature under argon conditions with a solution of sodium borohydride in THF, 0.07 M (Rh:NaBH₄=1:12 molar ratio), washed with H₂O and THF and left open to dry at room temperature. The resulting catalysts are reported in Table 7 as entries Si—Rh-1 to Si—Rh-3.

### Example 9

### Rhodium-Containing Organosilica Catalytic Reactions—Hydrogenation of Arenes

The substrate (2 mmol, 1 equiv) and Si—Rh catalyst prepared in example 8 (from 1 to 2.5 mol %) are combined in solvent and stirred under a hydrogen atmosphere (1 atm) at room temperature. The conversion with respect to the substrate is determined by GC/MS analysis. The results are summarized in Table 8.

TABLE 7

| | | | Pore | Pore | MTES:RhCl₃xH₂O:H⁺: |
|---|---|---|---|---|---|
| | Loading | Surface | Size | Volume | H₂Oₜₒₜₐₗ:NaOH |
| Entry | (mmol/g) | (m²/g) | (Å) | (cm³/g) | (equiv) |
| Si-0-A | 0.00 | 591 | 46 | 0.68 | 1:0.000:0.003: |
| | | | | | 4.89:0.023 |
| Si—Rh-1 | 0.042 | 508 | 50 | 0.78 | 1:0.004:0.003: |
| | | | | | 11.48:0.026 |
| Si—Rh-2 | 0.099 | 513 | 55 | 0.84 | 1:0.008:0.003: |
| | | | | | 13.80:0.053 |
| Si—Rh-3 | 0.224 | 516 | 75 | 1.039 | 1:0.0180:0.003: |
| | | | | | 18.10:0.099 |

TABLE 8

| | | ^{a} Mol % | Time | | | % Conversion ^{b} |
|---|---|---|---|---|---|---|
| Entry | Substrate | Catalyst | (h) | Solvent | Product | Product |
| 8-1 | 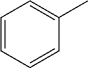 | 2.5 mol % Si—Rh-1 | 24 | MeOH (0.2M) | 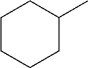 | 62 |
| 8-2 | 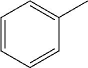 | 2.5 mol % Si—Rh-2 | 24 | MeOH (0.2M) | 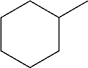 | 86 |
| 8-3 | 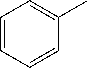 | 2.5 mol % Si—Rh-3 | 16 | MeOH (0.2M) | 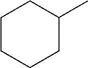 | 100 |
| 8-4 | 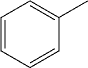 | 1 mol % Si—Rh-2 | 5 | Hexanes (0.5M) | 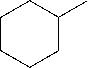 | 97 |
| 8-5 | 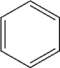 | 1 mol % Si—Rh-3 | 1 | Hexanes (0.5M) | 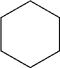 | 98 |
| 8-6 | 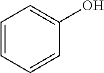 | 1 mol % Si—Rh-3 | 5 | Hexanes (0.5M) | 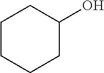 | 99 |

^{a} Mol % catalyst identified in Table 7 and used in reaction.
^{b} The conversion with respect to the substrate is determined by GC/MS analysis

### Example 10

### Preparation of Bimetallic Rhodium-Palladium-Containing Organosilica Catalyst

A mixture of MTES (27 g, 30 mL, 151.4 mmol) and 10 mL of 0.042 M HCl(aq) (0.42 mmol H+ and 555 mmol H₂O) is stirred vigorously for 15 minutes (or until the solution is homogeneous). The resulting solution is concentrated on rotavapor at 30° C. under reduced pressure until complete ethanol removal (with completeness being ensured by weighing). The resulting hydrogel is doped by addition of a solution of RhCl₃xH₂O and K₂PdCl₄ (from 0.002 to 0.054 equiv; Rh:Pd=1:3, 1:1 and 3:1 molar ratio) dissolved in distilled and deionized water (for better solubility) and 60 mL acetonitrile. To this mixture is added NaOH(aq) 1M (from 0.053 to 0.079 equiv) to favor the gelation process. The resulting homogeneous and clear gel is left open to dry at ambient temperature for about 4 days. The xerogel thereby obtained is then reduced at room temperature under argon conditions, first time with a solution of sodium triacetoxyborohydride in anhydrous THF (Pd:Na(AcO)₃BH=1:6 molar ratio, 0.03 M) and second time with a solution of sodium borohydride in anhydrous THF(Rh:NaBH₄=1:12 molar ratio, 0.02 M), washed with H₂O and THF and left open to dry at room temperature. The resulting catalysts are reported in Table 9 as entries Si—Rh—Pd-1 to Si—Rh—Pd-3 The Table 10 is providing the characterization of the bimetallic catalysts under BET analysis.

TABLE 9

| | | Metal | | |
|---|---|---|---|---|
| | Total metal | loading | | MTES:RhCl₃xH₂O: |
| | loading | (mmol/g) | | K₂PdCl₄:H⁺:H₂Oₜₒₜₐₗ: |
| Entry | (mmol/g) | Rh | Pd | NaOH (equiv) |
| Si-0-A | 0 | 0 | 0 | 1:0.000:0.000:00.003: |
| | | | | 4.89:0.023 |
| Si—Rh—Pd-1 | 0.08 | 0.02 | 0.06 | 1:0.0018:0.0054:0.003: |
| (25/75) | | | | 13.8:0.053 |
| Si—Rh—Pd-2 | 0.10 | 0.05 | 0.05 | 1:0.0036:0.0036:0.003: |
| (50/50) | | | | 14.51:0.066 |
| Si—Rh—Pd-3 | 0.10 | 0.07 | 0.03 | 1:0.0054:0.0018:0.003: |
| (75/25) | | | | 18.87:0.079 |

TABLE 10

| | Surface | Pore Size | Pore Volume |
|---|---|---|---|
| Entry | (m²/g) | (Å) | (cm³/g) |
| Si-0-A | 591 | 46 | 0.68 |
| Si—Rh—Pd-1 | 425 | 81 | 0.92 |
| (25/75) | | | |
| Si—Rh—Pd-2 | 463 | 60 | 0.95 |
| (50/50) | | | |
| Si—Rh—Pd-3 | 406 | 75 | 1.03 |
| (75/25) | | | |

### Example 11

### Rhodium-Palladium-Containing Organosilica Catalytic Reactions—Hydrogenation of Arenes

The substrate and Si—Rh—Pd bimetallic catalysts prepared in example 10 (from 1 to 0.5 mol % with respect to the substrate) are combined in solvent and stirred under hydrogen atmosphere (1 atm) at room temperature. The conversion with respect to the substrate is determined by GC/MS analysis. The results are summarized in Table 11.

### Example 12

### Preparation of Tetramethoxy-Ortho-Silicate-Based Xerogel

A mixture of tetramethoxy-ortho-silicate, TMOS, (39.27 g, 38.5 mL, 0.258 mol) and 21.5 mL of 0.045 M HCl(aq) (1.0 mmol H+ and 1.191 mol H₂O) is stirred vigorously for 15 minutes (or until the solution is homogeneous). The resulting solution is concentrated on rotavapor at 30° C. under reduced pressure until complete methanol removal (with completeness being ensured by weighing) and 75 mL acetonitrile is added. To favor the gelation process 10 ml (0.004 equiv) NaOH(aq) 0.1 M is added. The resulting homogeneous and clear gel is left open to dry at ambient temperature for about 4 days. The xerogel thereby obtained is washed with H₂O, MeOH and THF and left open to dry at room temperature. The resulting tetramethoxy-ortho-silicate-based xerogel is reported as entry Si—O—B.

TABLE 11

| | | ^{a} Mol % | Time | | | ^{b} Conv. |
|---|---|---|---|---|---|---|
| Entry | Substrate | Catalyst | (h) | Solvent | Product | (%) |
| 11-1 | 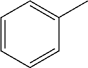 | 1 mol % Si—Rh—Pd-1 | 16 | MeOH (0.2M) | 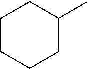 | 87 |
| 11-2 | 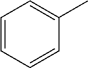 | 1 mol % Si—Rh—Pd-2 | 16 | MeOH (0.2M) | 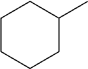 | 57 |
| 11-3 | 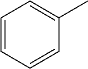 | 1 mol % Si—Rh—Pd-3 | 16 | MeOH (0.2M) | 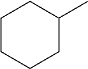 | 75 |
| 11-4 | 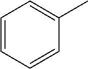 | 1 mol % Si—Rh—Pd-3 | 16 | Hexanes (0.25M) | 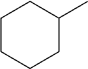 | 87 |
| 11-5 | 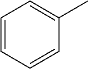 | 0.5 mol % Si—Rh—Pd-1 | 16 | Hexanes (0.25M) | 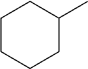 | 100 |
| 11-6 | 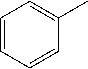 | 1 mol % Si—Rh—Pd-1 | 5 | Hexanes (0.5M) | 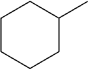 | 100 |
| 11-7 | 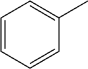 | 1 mol % Si—Rh—Pd-2 | 16 | Hexanes (0.25M) | 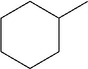 | 100 |
| 11-8 | 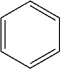 | 1 mol % Si—Rh—Pd-1 | 1 | Hexanes (0.5M) | 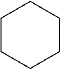 | 100 |
| 11-9 | 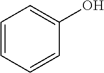 | 1 mol % Si—Rh—Pd-1 | 3 | Hexanes (0.5M) | 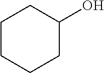 | 100 |

^{a} Mol % catalyst identified in Table 9 and used in reaction.
^{b} The conversion with respect to the substrate is determined by GC/MS analysis

### Example 13

### Preparation of Nickel-Containing Organosilica Catalyst

A mixture of TMOS (78.54 g, 77 mL, 0.516 mol) and 43 mL of 0.045 M HCl(aq) (1.9 mmol H+ and 2.382 mol H₂O) is stirred vigorously for 15 minutes (or until the solution is homogeneous). The resulting solution is concentrated on rotavapor at 30° C. under reduced pressure until complete methanol removal (with completeness being ensured by weighing). The resulting hydrogel is doped by addition of a solution of NiCl₂ (from 0.014 to 0.041 equiv) dissolved in distilled and deionized water (for better solubility) and 60 mL acetonitrile. To this mixture is added NaOH(aq) 0.1 M (from 0.003 to 0.005 equiv) to favor the gelation process. The resulting homogeneous and clear gel is left open to dry at ambient temperature for about 4 days. The resulting catalysts are reported in Table 12 as entries Si—Ni-1 to Si—Ni-3.

### Example 14A

### Nickel-Containing Organosilica Catalytic Reactions—Hydrogenation of Aryl Nitro Groups in the Presence of Halides

For the in situ generation of nickel(0) catalyst the Si—Ni^{II} xerogel obtained from example 13 (1 g, 0.5 mmol Ni, 0.5 mmol/g loading Ni^{II}) is reduced with a solution of sodium borohydride in anhydrous THF (Ni:NaBH₄=1:2 molar ratio, 0.02 M) at room temperature under argon conditions. After 1 h the xerogel, which is initially light green, changed to black indicating that nickel(0) is formed. The black solid is washed under argon conditions (3×50 mL anhydrous THF and 2×50 ml anhydrous MeOH). The black solid is dried under vacuum and kept under argon. The substrate, 4-chloronitrobenzene (0.788 g, 5 mmol, 1 equiv) dissolved in anhydrous methanol is added to the black catalyst and the mixture is purged two times vacuum/hydrogen and magnetically stirred at room temperature under hydrogen conditions (1 atm). After completion of the reaction (24 h) the catalyst is removed by filtration and the filtrate is analyzed by GC/MS (Table 13, entry 13-1).

### Example 14B

### Nickel-Containing Organosilica Catalytic Reactions—Hydrogenation of Aryl Nitro Groups in the Presence of Halides

For the in situ generation of nickel(0) catalyst the Si—Ni^{II} xerogel obtained from example 13 (1 g, 0.5 mmol Ni, 0.5 mmol/g loading Ni^{II}) is reduced with a solution of sodium borohydride in anhydrous DMF (Ni:NaBH₄=1:5 molar ratio, 0.05 M) in the presence of the 4-bromonitrobenzene (0.505 g, 2.5 mmol) at room temperature under hydrogen conditions (1 atm). The conversion with respect to the substrate is determined by GC/MS analysis (Table 13, entries 13-2, 13-3).

TABLE 12

| | | | Pore | Pore | TMOS:NiCl₂:H⁺: |
|---|---|---|---|---|---|
| | Loading | Surface | Size | Volume | H₂Oₜₒₜₐₗ:NaOH |
| Entry | (mmol/g) | (m²/g) | (Å) | (cm³/g) | (equiv) |
| Si-0-B | 0 | 621 | 30 | 0.32 | 1:0.000:0.004:6.22: |
| | | | | | 0.003 |
| Si—Ni-1 | 0.15 | 684 | 37 | 0.64 | 1:0.014:0.004:8.48: |
| | | | | | 0.003 |
| Si—Ni-2 | 0.29 | 510 | 30 | 0.35 | 1:0.027:0.004:11.03: |
| | | | | | 0.004 |
| Si—Ni-3 | 0.52 | 492 | 50 | 0.75 | 1:0.041:0.004:13.75: |
| | | | | | 0.005 |

TABLE 13

| | | ^{a} Mol % | Time | | | % Conversion ^{b} | |
|---|---|---|---|---|---|---|---|
| Entry | Substrate | Catalyst | (h) | Solvent | Product | Product | Aniline |
| 13-1 | 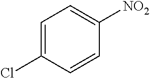 | 10 mol % Si—Ni-3 | 24 | MeOH | 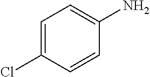 | 98 | 0 |
| 13-2 | 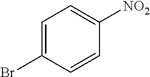 | 20 mol % Si—Ni-3 | 1 | DMF | 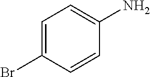 | 50 | 0 |
| 13-3 | 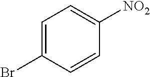 | 20 mol % Si—Ni-3 | 5 | DMF | 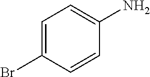 | 85 | 0 |

^{a} Mol % catalyst identified in Table 12 and used in reaction.
^{b} The conversion with respect to the substrate is determined by GC/MS analysis

### Example 15

### Preparation of Ruthenium-Containing Organosilica Catalyst

A mixture of MTES, (27 g, 30 mL, 151.4 mmol) and 10 mL of 0.042 M HCl(aq) (0.42 mmol H+ and 555 mmol H₂O) is stirred vigorously for 15 minutes (or until the solution is homogeneous). The resulting solution is concentrated on rotavapor at 30° C. under reduced pressure until complete ethanol removal (with completeness being ensured by weighing). The resulting hydrogel is doped by addition of a solution of RuCl₃ (from 0.004 to 0.009 equiv) dissolved in distilled and deionized water (for better solubility) and 60 mL of acetonitrile. To this mixture is added NaOH(aq) 1M (from 0.033 to 0.066 equiv) to favor the gelation process. The resulting homogeneous and clear gel is left open to dry at ambient temperature for about 4 days. The xerogel thereby obtained is then reduced under argon at room temperature with a solution of sodium borohydride in THF/H₂O (4:1, 80 mL; Ru:NaBH₄=1:6 molar ratio), washed with THF and H₂O and dried under argon under reduced pressure at room temperature. The resulting catalysts are reported in Table 14 as entries Si—Ru-1 and Si—Ru-2.

TABLE 14

| | | | Pore | Pore | MTES:RuCl₃:H⁺: |
|---|---|---|---|---|---|
| | Loading | Surface | Size | Volume | H₂Oₜₒₜₐₗ:NaOH |
| Entry | (mmol/g) | (m²/g) | (Å) | (cm³/g) | (equiv) |
| Si—Ru-1 | 0.06 | 657 | 63 | 1.03 | 1:0.004:0.003:7.25: |
| | | | | | 0.033 |
| Si—Ru-2 | 0.12 | 410 | 65 | 0.72 | 1:0.009:0.003:9.01: |
| | | | | | 0.066 |

### Example 16

### Ruthenium-Containing Organosilica Catalytic Reactions—Reduction of a Double Bond

Experimental conditions: The substrate n-octene (0.5 mmol, 1 equiv) and the Si—Ru catalyst prepared in example 15 (0.02 to 0.055 equiv) in ethanol (5 mL) are stirred at room temperature under hydrogen atmosphere (1 to 3 atm.). After completion of the reaction, the catalyst is filtered off and washed with ethanol. Conversion to the desired product is determined by GC/MS analysis with respect to the substrate. The results are summarized in Table 15.

TABLE 15

| | | % mol | | | | |
|---|---|---|---|---|---|---|
| Entry | Substrate | catalyst | H₂ pressure | Time | Product | Conversion |
| 15-1 | 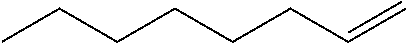 | 2 mol % Si—Ru-2 | 1 atm | 17 h | 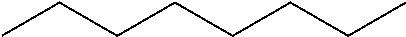 | 4% |
| 15-2 | 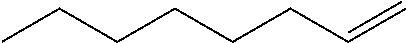 | 5 mol % Si—Ru-2 | 1 atm | 95 h | 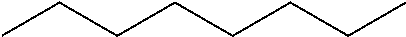 | 12% |
| 15-3 | 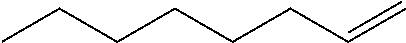 | 5.5 mol % Si—Ru-2 | 3 atm | 17 h | 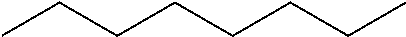 | 100% |
| 15-4 | 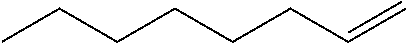 | 3 mol % Si—Ru-2 | 2 atm | 17 h | 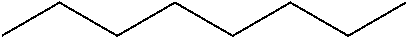 | 100% |

### Example 17

### Preparation of Copper-Containing Organosilica Catalyst

Procedure A: A mixture of MTES (27 g, 30 mL, 151.4 mmol) and 10 mL of 0.042 M HCl(aq) (0.42 mmol H+ and 555 mmol H₂O) is stirred vigorously for 15 minutes (or until the solution is homogeneous). The resulting solution is concentrated on rotavapor at 30° C. under reduced pressure until complete ethanol removal (with completeness being ensured by weighing). The resulting hydrogel is doped by addition of a solution of Cu(NO₃)₂ (or Cu(OAc)₂) (from 0.004 to 0.028 equiv) dissolved in distilled and deionized water (for better solubility) and 60 mL of acetonitrile. To this mixture is added NaOH(aq) 1M (from 0.023 to 0.073 equiv) to favor the gelation process. The resulting homogeneous and clear gel is left open to dry at ambient temperature for about 4 days. The xerogel thereby obtained is then reduced under argon at room temperature with a solution of sodium borohydride in THF/H₂O (4:1, 80 mL; Cu:NaBH₄=1:6 molar ratio), washed with THF and H₂O and dried under argon under reduced pressure at room temperature. The results are summarized in Table 16.

Procedure B: A mixture of MTES (27 g, 30 mL, 151.4 mmol) and 10 mL of 0.042 M HCl(aq) (0.42 mmol H+ and 555 mmol H₂O) is stirred vigorously for 15 minutes (or until the solution is homogeneous). The resulting solution is doped by addition of a solution of Cu(NO₃)₂ (from 0.004 to 0.028 equiv) dissolved in distilled and deionized water (for better solubility) and 30 mL of acetonitrile. To this mixture is added NaOH(aq) 1M (from 0.023 to 0.073 equiv) to favor the gelation process. The resulting homogeneous and clear gel is left open to dry at ambient temperature for about 4 days. The xerogel thereby obtained is then reduced under argon at room temperature with a solution of sodium borohydride in THF/H₂O (4:1, 80 mL; Cu:NaBH4=1:6 molar ratio), washed with THF and H₂O and dried under argon under reduced pressure at room temperature. The results are summarized in Table 16.

Procedure C. A mixture of MTES (27 g, 30 mL, 151.4 mmol) and 10 mL of 0.042 M HCl(aq) (0.42 mmol H+ and 555 mmol H₂O) is stirred vigorously for 15 minutes (or until the solution is homogeneous). The resulting solution is doped by addition of a solution of Cu(NO₃)₂ (from 0.004 to 0.028 equiv) dissolved in distilled and deionized water (for better solubility). To this mixture is added NaOH(aq) 1M (from 0.023 to 0.073 equiv) to favor the gelation process. The resulting homogeneous and clear gel is left open to dry at ambient temperature for about 4 days. The xerogel thereby obtained is then reduced under argon at room temperature with a solution of sodium borohydride in THF/H₂O (3:1, 80 mL; Cu:NaBH₄=1:6 molar ratio), washed with THF and H₂O and dried under argon under reduced pressure at room temperature. The results are summarized in Table 16.

TABLE 16

| | | | Pore | Pore | MTES:Cu(NO₃)₂:H⁺: |
|---|---|---|---|---|---|
| | Loading | Surface | Size | Volume | H₂Oₜₒₜₐₗ:NaOH |
| Entry | (mmol/g) | (m²/g) | (Å) | (cm³/g) | (equiv) |
| Si—Cu-1^{a} | 0.037 | 626 | 66 | 1.08 | 1:0.004:0.003:6.72: |
| | | | | | 0.023 |
| Si—Cu-2^{a} | 0.029 | 670 | 55 | 1.04 | 1:0.004:0.003:7.25: |
| | | | | | 0.033 |
| Si—Cu-3^{c} | 0.150 | 455 | 71 | 0.83 | 1:0.008:0.003:8.31: |
| | | | | | 0.053 |
| Si—Cu-4^{b} | 0.955 | 514 | 64 | 0.87 | 1:0.028:0.003:9.36: |
| | | | | | 0.073 |
| Si—Cu-5^{a} | 0.073 | 582 | 78 | 1.13 | 1:0.017:0.003:7.25: |
| | | | | | 0.033 |
| Si—Cu-6^{a} | 0.130 | 352 | 98 | 0.84 | 1:0.010:0.003:9.01: |
| | | | | | 0.066 |
| Si—Cu-7^{c} | 0.197 | 606 | 74 | 1.13 | 1:0.028:0.003:11.19: |
| | | | | | 0.073 |

^{a}procedure A,
^{b}procedure B
^{c}procedure C

### Example 18

### Copper-Containing Organosilica Catalytic Reactions—Reduction of a Double Bond

The substrate (0.5 mmol, 1 equiv) and Si—CuO catalyst prepared in example 17 (0.02 to 0.1 equiv) in ethanol (5 mL) are stirred at room temperature under hydrogen atmosphere (1 atm.). The catalyst is filtered off and washed with ethanol. Conversion to the desired product is determined by GC/MS analysis with respect to the substrate. The results are summarized in Table 17.

TABLE 17

| | | % mol | | | |
|---|---|---|---|---|---|
| Entry | Substrate | catalyst | Time | Product | Conversion |
| 17-1 | 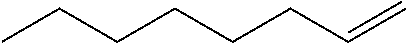 | 2 mol % Si—Cu-2 | 17 h | 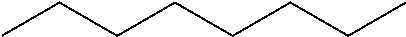 | 78% |
| 17-2 | 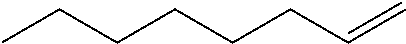 | 2 mol % Si—Cu-1 | 42 h | 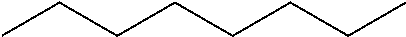 | 36% |
| 17-3 | 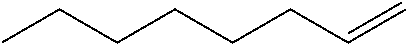 | 4 mol % Si—Cu-3 | 65 h | 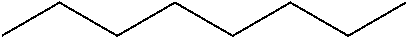 | 37% |
| 17-4 | 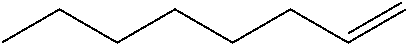 | 2 mol % Si—Cu-4 | 17 h | 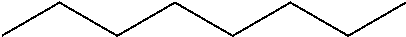 | 55% |
| 17-5 | 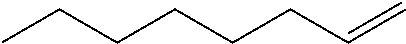 | 2 mol % Si—Cu-4 | 65 h | 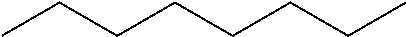 | 78 % |
| 17-6 | 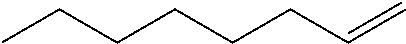 | 8 mol % Si—Cu-4 | 17 h | 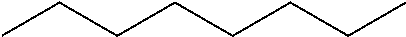 | 77% |
| 17-7 | 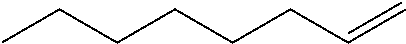 | 5 mol % Si—Cu-5 | 17 h | 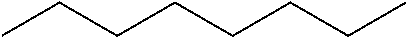 | 20% |
| 17-8 | 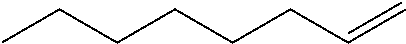 | 10 mol % Si—Cu-7 | 5 h 40 PSI | 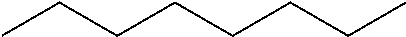 | 58% |
| 17-9 | 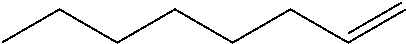 | 10 mol % Si—Cu-6 | 17 h | 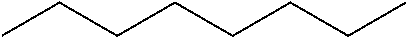 | 15% |

### Example 19

### Preparation of Iron-Containing Organosilica Catalyst

A mixture of MTES (27 g, 30 mL, 151.4 mmol) and 10 mL of 0.042 M HCl(aq) (0.42 mmol H+ and 555 mmol H₂O) is stirred vigorously for 15 minutes (or until the solution is homogeneous). The resulting solution is concentrated on rotavapor at 30° C. under reduced pressure until complete ethanol removal (with completeness being ensured by weighing). The resulting hydrogel is doped by addition of a solution of FeCl₃ (from 0.005 to 0.010 equiv) dissolved in distilled and deionized water (for better solubility) and 60 mL of acetonitrile. To this mixture is added NaOH(aq) 1M (0.066 equiv) to favor the gelation process. The resulting homogeneous and clear gel is left open to dry at ambient temperature for about 4 days. The xerogel thereby obtained is then reduced at room temperature with a solution of sodium borohydride in THF/H₂O (4:1, 80 mL; Fe:NaBH₄=1:20 molar ratio), washed with THF and H₂O and left open to dry at room temperature. The resulting catalysts are reported in Table 18 as entries Si—Fe-1 and Si—Fe-2.

TABLE 18

| | | | Pore | Pore | MTES:FeCl₃:H⁺: |
|---|---|---|---|---|---|
| | Loading | Surface | Size | Volume | H₂O_{(total:}NaOH |
| Entry | (mmol/g) | (m²/g) | (Å) | (cm³/g) | (equiv) |
| Si—Fe-1 | 0.06 | 626 | 59 | 1.10 | 1:0.005:0.003:9.01: |
| | | | | | 0.066 |
| Si—Fe-2 | 0.15 | 443 | 66 | 0.73 | 1:0.010:0.003:9.01: |
| | | | | | 0.066 |

### Example 20

### Iron-Containing Organosilica Catalytic Reactions—Reduction of a Double Bond

A mixture of the substrate (0.5 mmol, 1 equiv) and Si—Fe catalyst prepared in example 19 (0.02 to 0.04 equiv) in ethanol (5 mL) is stirred at room temperature under hydrogen atmosphere (1 atm.). The catalyst is filtered off and washed with ethanol. Conversion to the desired product is determined by GC/MS analysis with respect to the substrate. The results are summarized in Table 19.

TABLE 19

| | | % mol | | | |
|---|---|---|---|---|---|
| Entry | Substrate | catalyst | Time | Product | Conversion |
| 19-1 | 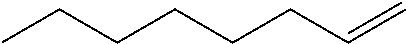 | 2 mol % Si—Fe-1 | 17 h | 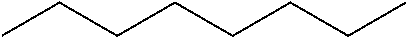 | 31% |
| 19-2 | 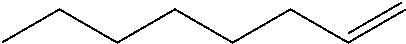 | 4 mol % Si—Fe-1 | 65 h | 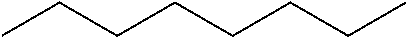 | 39% |
| 19-3 | 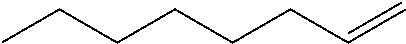 | 5 mol % Si—Fe-2 | 17 h 45 PSI | 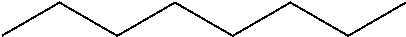 | 6% |

### Example 21

### Palladium-Containing Organosilica Catalytic Reactions—Synthesis of Acetophenone Analogs

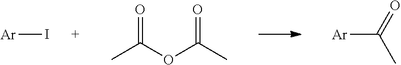

A mixture of a 4-substituted iodobenzene of formula Ar—I (0.5 mmol, 1 equiv), acetic anhydride (0.997 mmol, 1.05 equiv) lithium chloride (3.04 mmol, 3.2 equiv), diisopropylethylamine (3.04 mmol, 3.2 equiv) and the Si—Pd catalyst prepared in example 1 (0.02 equiv) in DMF (5 mL) is stirred at 100° C. The catalyst is filtered off and washed with dichloromethane. Conversion to the coupling product is determined by GC/MS analysis with respect to the substrate. The results are summarized in Table 20.

TABLE 20

| | | % mol | | | |
|---|---|---|---|---|---|
| Entry | Ar—I | catalyst | Time | Product | Conversion |
| 20-1 | 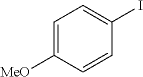 | 2 mol % Si—Pd-2 | 18 h | 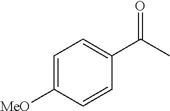 | 24% |
| 20-2 | 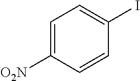 | 2 mol % Si—Pd-2 | 18 h | 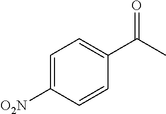 | 100% |
| 20-3 | 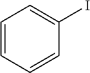 | 2 mol % Si—Pd-2 | 42 h | 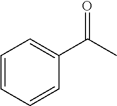 | 51% |

### Example 22

### Palladium-Containing Organosilica Catalytic Reactions—Buchwald-Hartwig Amination

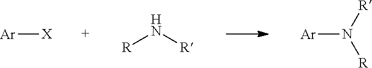

A mixture of a 1-halo-4-nitrobenzene (0.5 mmol, 1 equiv)) amine (1.5 mmol, 3 equiv), sodium tert-butoxide (0.7 mmol, 1.4 equiv) and the Si—Pd catalyst prepared in example 1 (0.02 to 0.06 equiv) in dioxane (5 mL) is stirred at 100° C. The catalyst is filtered off and washed with dichloromethane. Conversion to the coupling product is determined by GC/MS analysis with respect to the substrate. The results are summarized in Table 21.

TABLE 21

| | | | RNHR′ | % mol | | | |
|---|---|---|---|---|---|---|---|
| Entry | Ar—X | RNHR′ | equiv | catalyst | Time | Product | Conversion |
| 21-1 | 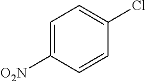 | 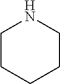 | 3 | 6 mol % Si—Pd-3 | 48 h | 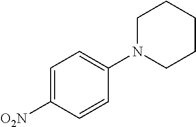 | 42% |
| 21-2 | 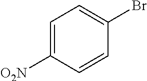 | 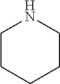 | 3 | 6 mol % Si—Pd-3 | 48 h | 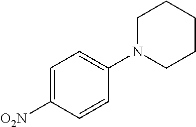 | 63% |
| 21-3 | 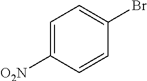 | 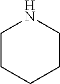 | 2 | 2 mol % Si—Pd-3 | 65 h | 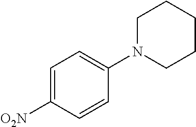 | 69% |
| 21-4 | 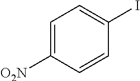 | 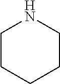 | 3 | 6 mol % Si—Pd-3 | 48 h | 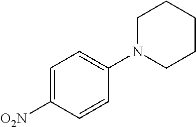 | 54% |

### Example 22

### Palladium-Containing Organosilica Catalytic Reactions—Catalytic Hydrogenation and Hydrogenolysis

A mixture of the substrate (0.5 mmol, 1 equiv) and Si—Pd catalyst prepared in example 1 (0.01 to 0.04 equiv) in ethanol (5 mL) is stirred at room temperature under hydrogen atmosphere (1 atm.). The catalyst is filtered off and washed with ethanol. Conversion to the desired product is determined by GC/MS analysis with respect to the substrate. The results are summarized in Table 22.

TABLE 22

| | | % mol | | | |
|---|---|---|---|---|---|
| Entry | Substrate | catalyst | Time | Product | Conversion |
| 22-1 | 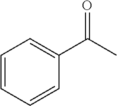 | 2 mol % Si—Pd-2 | 19 h | 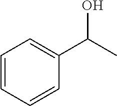 | 100% 2% PhEt |
| 22-2 | 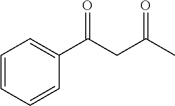 | 2 mol % Si—Pd-2 | 65 h | 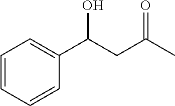 | 100% 2% diol |
| 22-3 | 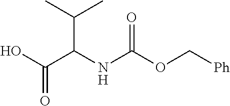 | 2 mol % Si—Pd-2 | 20 h | 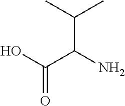 | 100% |
| 22-4 | 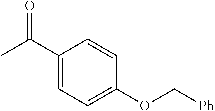 | 2 mol % Si—Pd-2 | 24 h | 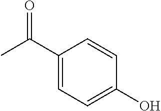 | 100% 10% diol |
| 22-5 | 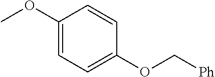 | 2 mol % Si—Pd-2 | 17 h | 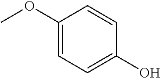 | 100% |
| 22-6 | 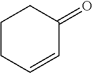 | 1 mol % Si—Pd-2 | 20 h | 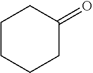 | 88% |
| 22-7 | 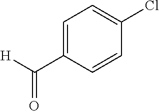 | 4 mol % Si—Pd-2 | 42 h | 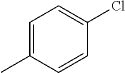 | 100% |
| 22-8 | 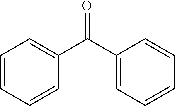 | 2 mol % Si—Pd-2 | 16 h | 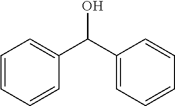 | 89% |
| 22-9 | 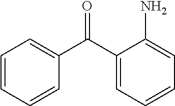 | 2 mol % Si—Pd-2 | 90 h | 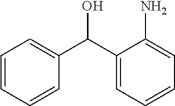 | 80% |
| 22-10 | 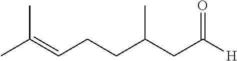 | 2 mol % Si—Pd-2 | 19 h | 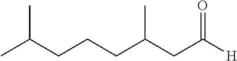 | 100% |
| 22-11 | 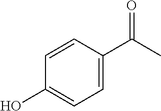 | 4 mol % Si—Pd-2 | 48 h | 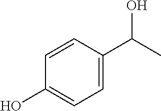 | 65% |
| 22-12 | 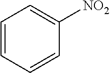 | 1 mol % Si—Pd-2 | 65 h | 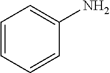 | 100% |
| 22-13 | 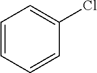 | 1 mol % Si—Pd-2 | 41 h | 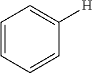 | 100% |
| 22-14 | 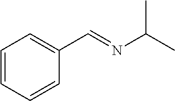 | 2 mol % Si—Pd-2 | 19 h | 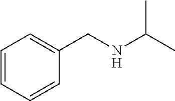 | 97% |
| 22-15 | 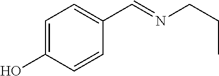 | 2 mol % Si—Pd-2 | 19 h | 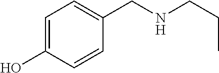 | 100% |
| 22-16 | 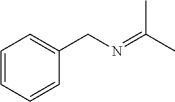 | 4 mol % Si—Pd-2 | 44 h | 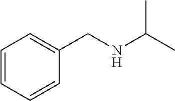 | 46% |
| 22-17 | 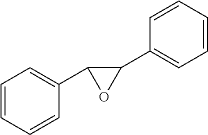 | 2 mol % Si—Pd-2 | 90 h | 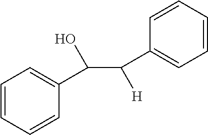 | 93% |

### Example 23

### Preparation of Silver-Containing Organosilica Catalyst

A mixture of MTES (27 g, 30 mL, 151.4 mmol) and 10 mL of 0.042 M HNO₃(aq) (0.42 mmol H⁺ and 554 mmol H₂O) is stirred vigorously for 15 minutes (or until the solution is homogeneous). The resulting solution is concentrated on rotavapor at 30° C. under reduced pressure until complete ethanol removal (with completeness being ensured by weighing). The resulting hydrogel is doped by addition of a solution of AgNO₃ (from 0.01 to 0.02 equiv) dissolved in distilled and deionized water (for better solubility) and 60 mL acetonitrile. To this mixture is added NaOH(aq) 1M (from 0.033 to 0.063 equiv) to favor the gelation process. The resulting homogeneous and clear gel is left open to dry at ambient temperature for about 4 days. The xerogel thereby obtained is then reduced at room temperature with a solution of sodium borohydride in THF (Ag:NaBH₄=1:12 molar ratio; 180 mL), washed with H₂O and THF and left open to dry at room temperature. The resulting catalysts are reported in Table 23 as entries Si—Ag-1 and Si—Ag-2.

TABLE 23

| | | | Pore | Pore | MTES:AgNO₃:H⁺: |
|---|---|---|---|---|---|
| | Loading | Surface | Size | Volume | H₂Oₜₒₜₐₗ:NaOH |
| Entry | (mmol/g) | (m²/g) | (Å) | (cm³/g) | (equiv) |
| Si—Ag-1 | 0.125 | 431 | 67 | 0.99 | 1:0.01:0.003:9.08: |
| | | | | | 0.033 |
| Si—Ag-2 | 0.28 | 445 | 47 | 0.73 | 1:0.02:0.003:10.85: |
| | | | | | 0.063 |

### Example 24

### Silver-Containing Organosilica Catalytic Reactions—Hydration of Nitrile

In a Schlenck tube, benzonitrile (0.5 mmol, 1 equiv) and the Si—Ag catalyst prepared in example 23, in water (10 mL) are stirred at 140° C. under argon atmosphere for 4 hours. After completion of the reaction, the catalyst is filtered off and washed with dichloromethane. The aqueous phase is extracted with dichloromethane. Organic fractions are combined and conversion to the product (benzamide) is determined by GC/MS analysis with respect to the substrate. The results are summarized in Table 24.

TABLE 24

| | | % Mol | Time | | ^{b}Con- |
|---|---|---|---|---|---|
| | | | | | version |
| Entry | Substrate | ^{a}catalyst | (h) | Product | (%) |
| 24-1 | 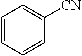 | 3 mol % Si—Ag-1 | 4 | 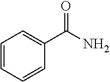 | 100 |

^{a}Mol % catalyst identified in Table 23 and used in reaction.
^{b}The conversion with respect to the substrate is determined by GC/MS analysis.

### Example 25

### Silver-Containing Organosilica Catalytic Reactions—Dehydrogenation of Alcohol

A mixture of 1-phenyl-1-propanol (0.1 mL, 0.729 mmol) and Si—Ag catalyst prepared in example 23 in m-xylene (10 mL) are stirred at 130° C. under argon atmosphere for 17 hours. The catalyst is filtered off and washed with dichloromethane. Conversion to the dehydrogenated product is determined by GC/MS analysis with respect to the substrate. The results are summarized in Table 25.

TABLE 25

| | | % Mol | Time | | ^{b}Conversion |
|---|---|---|---|---|---|
| Entry | Substrate | ^{a}catalyst | (h) | Product | (%) |
| 25-1 | 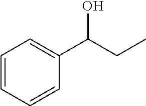 | 10 mol % Si—Ag-2 | 17 | 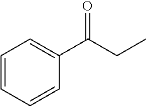 | 51 |

^{a}Mol % catalyst identified in Table 23 and used in reaction.
^{b}The conversion with respect to the substrate is determined by GC/MS analysis .

### Example 26

### Preparation of Bimetallic Platinum-Nickel Containing Organosilica Catalyst

A mixture of TMOS (30.6 g, 30 mL, 201.03 mmol) and 15 mL of 0.042 M HCl(aq) (0.42 mmol H⁺ and 831.13 mmol H₂O) is stirred vigorously for 15 minutes (or until the solution is homogeneous). The resulting solution is concentrated on rotavapor at 30° C. under reduced pressure until complete methanol removal (with completeness being ensured by weighing). The resulting hydrogel is doped by addition of a solution of K₂PtCl₄/NiCl₂ (from 0.004 to 0.01 equiv K₂PtCl₄ and from 0.003 to 0.008 equiv NiCl₂) dissolved in distilled and deionized water (for better solubility) and 60 mL acetonitrile. To this mixture is added NaOH(aq) 0.1 M (from 0.005 to 0.012 equiv) to favor the gelation process. The resulting homogeneous and clear gel is left open to dry at ambient temperature for about 4 days. The xerogel thereby obtained is then reduced at room temperature under argon conditions with a solution of sodium borohydride in anhydrous tetrahydrofuran (Pt+Ni:NaBH₄=1:12 molar ratio; 0.15 M), washed with H₂O and THF and dried at room temperature. The resulting catalysts are reported in Table 26 as entries Si—Pt—Ni-1 to Si—Pt—Ni-4. The Table 27 is providing the characterization of the bimetallic catalysts under BET analysis.

TABLE 26

| | | Metal | | |
|---|---|---|---|---|
| | Total metal | composition | | TMOS:K₂PtCl₄:NiCl₂: |
| | loading | (mmol/g) | | H⁺:H₂Oₜₒₜₐₗ:NaOH |
| Entry | (mmol/g) | Pt | Ni | (equiv) |
| Si-0-B | 0 | 0 | 0 | 1:0.000:0.000:0.004: |
| | | | | 6.22:0.003 |
| Si—Pt—Ni-1 | 0.15 | 0.07 | 0.08 | 1:0.005:0.003:0.003: |
| (52/48) | | | | 10.28:0.005 |
| Si—Pt—Ni-2 | 0.08 | 0.06 | 0.02 | 1:0.004:0.004:0.003: |
| (71/29) | | | | 11.57:0.007 |
| Si—Pt—Ni-3 | 0.09 | 0.03 | 0.06 | 1:0.010:0.006:0.003: |
| (36/64) | | | | 12.95:0.010 |
| Si—Pt—Ni-4 | 0.18 | 0.14 | 0.05 | 1:0.008:0.008:0.003: |
| (75/25) | | | | 14.32:0.012 |

TABLE 27

| | Surface | Pore Size | Pore Volume |
|---|---|---|---|
| Entry | (m²/g) | (Å) | (cm³/g) |
| Si-0-B | 621 | 30 | 0.32 |
| Si—Pt—Ni-1 | 344 | 37 | 0.33 |
| (52/48) | | | |
| Si—Pt—Ni-2 | 307 | 34 | 0.28 |
| (71/29) | | | |
| Si—Pt—Ni-3 | 132 | 43 | 0.24 |
| (36/64) | | | |
| Si—Pt—Ni-4 | 242 | 38 | 0.27 |
| (75/25) | | | |

### Example 27

### Platinum-Nickel Containing Organosilica Catalytic Reactions—Hydrogenation of Aryl Nitro Groups in the Presence of Halides

The nitro substrate (2 mmol, 1 equiv) and the Si—Pt—Ni catalyst prepared in example 26 are combined in methanol (10 mL) and stirred under a hydrogen atmosphere (1 atm) at room temperature until GC/MS analysis indicated maximum conversion. The results are summarized in Table 28.

TABLE 28

| | | ^{a} Mol % | | | % Conversion ^{b} | |
|---|---|---|---|---|---|---|
| Entry | Substrate | Catalyst | Time | Product | Product | Aniline |
| 28-2 | 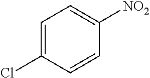 | 0.5 mol % Si—Pt—Ni-1 | 45 min | 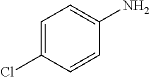 | 96 | 6 |
| 28-4 | 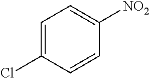 | 0.5 mol % Si—Pt—Ni-2 | 45 min | 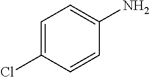 | 99 | 1 |
| 28-6 | 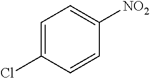 | 0.5 mol % Si—Pt—Ni-3 | 60 min | 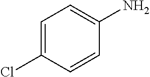 | 95 | 3 |
| 28-8 | 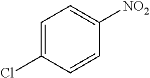 | 0.5 mol % Si—Pt—Ni-4 | 60 min | 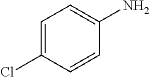 | 97 | 3 |

^{a} Mol % catalyst identified in Table 26 and used in reaction.
^{b} The conversion with respect to the substrate is determined by GC/MS analysis

### Example 28

### Preparation of Platinum-Palladium-Containing Organosilica Catalyst

A mixture of MTES (27 g, 30 mL, 151.4 mmol) and 10 mL of 0.042 M HCl (aq) (0.42 mmol H⁺ and 555 mmol. H₂O) is stirred vigorously for 15 minutes (or until the solution is homogeneous). The resulting solution is concentrated on rotavapor at 30° C. under reduced pressure until complete ethanol removal (with completeness being ensured by weighing). The resulting hydrogel is doped by addition of a solution of K₂PtCl₄ and K₂PdCl₄ (from 0.0036 to 0.011 equiv, Pt:Pd=1:3, 1:1 and 3:1 molar ratio) dissolved in distilled and deionized water (for better solubility) and 60 mL acetonitrile. To this mixture is added NaOH(aq) 1M (from 0.053 to 0.079 equiv) to favor the gelation process. The resulting homogeneous and clear gel is left open to dry at ambient temperature for about 4 days. The xerogel thereby obtained is then reduced at room temperature under argon conditions, first time with a solution of sodium triacetoxyborohydride in anhydrous THF (Pd:Na(AcO)₃BH=1:6 molar ratio, 0.06 M) and second time with a solution of sodium borohydride in anhydrous THF(Pt:NaBH₄=1:12 molar ratio, 0.04 M), washed with H₂O and THF and left open to dry at room temperature. The resulting catalysts are reported in Table 29 as entries Si—Pt—Pd-1 to Si—Pt—Pd-3. The Table 30 is providing the characterization of the bimetallic catalysts under BET analysis.

TABLE 29

| | | Metal | | |
|---|---|---|---|---|
| | Total metal | composition | | MTES:K₂PtCl₄:K₂PdCl₄: |
| | loading | (mmol/g) | | H⁺:H₂Oₜₒₜₐₗ:NaOH |
| Entry | (mmol/g) | Pt | Pd | (equiv) |
| Si-0-A | 0 | 0 | 0 | 1:0.000:0.000:0.003: |
| | | | | 4.89:0.023 |
| Si—Pt—Pd-1 | 0.14 | 0.03 | 0.11 | 1:0.0036:0.011:0.003: |
| (20/80) | | | | 11.97:0.053 |
| Si—Pt—Pd-2 | 0.13 | 0.07 | 0.06 | 1:0.073:0.0073:0.003: |
| (47/53) | | | | 12.67:0.066 |
| Si—Pt—Pd-3 | 0.18 | 0.14 | 0.04 | 1:0.011:0.0036:0.003: |
| (75/25) | | | | 13.38:0.079 |

TABLE 30

| | Surface | Pore Size | Pore Volume |
|---|---|---|---|
| Entry | (m²/g) | (Å) | (cm³/g) |
| Si-0-A | 591 | 46 | 0.68 |
| Si—Pt—Pd-1 | 526 | 71 | 0.93 |
| (20/80) | | | |
| Si—Pt—Pd-2 | 540 | 75 | 0.99 |
| (47/53) | | | |
| Si—Pt—Pd-3 | 460 | 80 | 0.93 |
| (75/25) | | | |

### Example 29

### Platinum-Palladium-Containing Organosilica Catalytic Reactions—Hydrogenation of Arenes Under Mild Conditions

The substrate (2 mmol, 1 equiv) and the Si—Pt—Pd catalyst prepared in example 28 are combined in methanol or hexanes (10 mL) and stirred under a hydrogen atmosphere (1 atm) at room temperature. The conversion with respect to the substrate is determined by GC/MS analysis. The results are summarized in Table 31.

TABLE 31

| | | ^{a} Mol % | Time | | | ^{b} Conversion |
|---|---|---|---|---|---|---|
| Entry | Substrate | Catalyst | (h) | Solvent | Product | (%) |
| 31-1 | 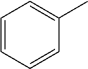 | 1 mol % Si—Pt—Pd-1 | 24 | MeOH (0.2M) | 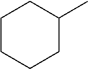 | 37 |
| 31-2 | 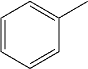 | 1 mol % Si—Pt—Pd-2 | 24 | MeOH (0.2M) | 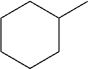 | 30 |
| 31-3 | 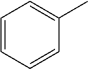 | 1 mol % Si—Pt—Pd-3 | 24 | MeOH (0.2M) | 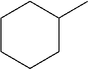 | 65 |
| 31-4 | 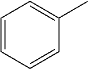 | 2.5 mol % Si—Pt—Pd-3 | 24 | Hexanes (0.5M) | 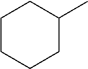 | 97 |
| 31-5 | 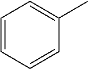 | 2.5 mol % Si—Pt—Pd-3 | 24 | Hexanes (0.5M) | 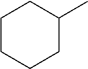 | 99 |
| 31-6 | 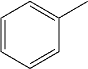 | 2.5 mol % Si—Pt—Pd-3 | 24 | Hexanes (0.5M) | 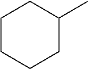 | 100 |

^{a} Mol % catalyst identified in Table 29 and used in reaction.
^{b} The conversion with respect to the substrate is determined by GC/MS analysis

### Example 30

### Preparation of Rhodium-Platinum-Containing Organosilica Catalyst

A mixture of MTES (27 g, 30 mL, 151.4 mmol) and 10 mL of 0.042 M HCl(aq) (0.42 mmol H⁺ and 555 mmol H₂O) is stirred vigorously for 15 minutes (or until the solution is homogeneous). The resulting solution is concentrated on rotavapor at 30° C. under reduced pressure until complete ethanol removal (with completeness being ensured by weighing). The resulting hydrogel is doped by addition of a solution of RhCl₃xH₂O and K₂PtCl₄ (from 0.0018 to 0.0054 equiv, Rh:Pt=1:3, 1:1 and 3:1 molar ratio) dissolved in distilled and deionized water (for better solubility) and 60 mL acetonitrile. To this mixture is added NaOH(aq) 1M (from 0.053 to 0.079 equiv) to favor the gelation process. The resulting homogeneous and clear gel is left open to dry at ambient temperature for about 4 days. The xerogel thereby obtained is then reduced at room temperature under argon conditions with a solution of sodium borohydride in anhydrous THF (Rh+Pt:NaBH₄=1:12), 0.12 M), washed with H₂O and THF and left open to dry at room temperature. The resulting catalysts are reported in Table 32 as entries Si—Rh—Pt-1 to Si—Rh—Pt-3. The Table 33 is providing the characterization of the bimetallic catalysts under BET analysis.

TABLE 32

| | | Metal | | |
|---|---|---|---|---|
| | Total metal | composition | | MTES:RhCl₃xH₂O: |
| | loading | (mmol/g) | | K₂PtCl₄:H⁺:H₂Oₜₒₜₐₗ: |
| Entry | (mmol/g) | Rh | Pt | NaOH (equiv) |
| Si-0-A | 0 | 0 | 0 | 1:0.000:0.000:0.003: |
| | | | | 4.89:0.023 |
| Si—Rh—Pt-1 | 0.09 | 0.03 | 0.06 | 1:0.0018:0.0054:0.003: |
| (32/68) | | | | 11.97:0.053 |
| Si—Rh—Pt-2 | 0.07 | 0.04 | 0.03 | 1:0.0036:0.0036:0.003: |
| (60/40) | | | | 15.24:0.066 |
| Si—Rh—Pt-3 | 0.11 | 0.09 | 0.02 | 1:0.0054:0.0018:0.003: |
| (80/20) | | | | 18.14:0.079 |

TABLE 33

| | Surface | Pore Size | Pore Volume |
|---|---|---|---|
| Entry | (m²/g) | (Å) | (cm³/g) |
| Si-0-A | 591 | 46 | 0.68 |
| Si—Rh—Pt-1 | 511 | 66 | 0.91 |
| (32/68) | | | |
| Si—Rh—Pt-2 | 526 | 72 | 0.99 |
| (60/40) | | | |
| Si—Rh—Pt-3 | 500 | 76 | 1.05 |
| (80/20) | | | |

### Example 31

### Rhodium-Platinum-Containing Organosilica Catalytic Reactions—Hydrogenation of Arenes Under Mild Conditions

The substrate (2.5 mmol, 1 equiv) and the Si—Rh—Pt catalyst prepared in example 30 are combined in hexanes (10 mL) and stirred under a hydrogen atmosphere (1 atm) at room temperature. The conversion with respect to the substrate is determined by GC/MS analysis. The results are summarized in Table 34.

TABLE 34

| | | ^{a} Mol % | Time | | ^{b} Conversion |
|---|---|---|---|---|---|
| Entry | Substrate | Catalyst | (h) | Product | (%) |
| 34-1 | 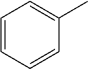 | 0.5 mol % Si—Rh—Pt-1 | 1 | 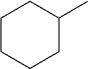 | 100 |
| 34-2 | 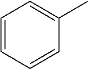 | 0.1 mol % Si—Rh—Pt-1 | 3 | 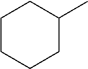 | 100 |
| 34-3 | 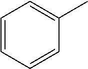 | 1 mol % Si—Rh—Pt-2 | 1 | 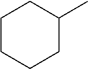 | 100 |
| 34-4 | 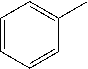 | 1 mol % Si—Rh—Pt-3 | 1 | 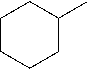 | 60 |
| 34-5 | 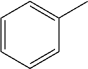 | 1 mol % Si—Rh—Pt-3 | 3 | 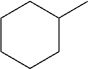 | 100 |
| 34-6 | 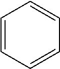 | 0.1 mol % Si—Rh—Pt-1 | 1 | 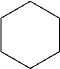 | 100 |
| 34-7 | 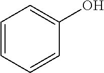 | 0.1 mol % Si—Rh—Pt-1 | 1 | 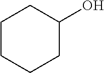 | 98 |

^{a} Mol % catalyst identified in Table 32 and used in reaction.
^{b} The conversion with respect to the substrate is determined by GC/MS analysis

### Example 32

### Preparation of Iridium-Containing Organosilica Catalyst

A mixture of MTES (27 g, 30 mL, 151.4 mmol) and 10 mL of 0.042 M HNO₃(aq) (0.42 mmol H⁺ and 554 mmol H₂O) is stirred vigorously for 15 minutes (or until the solution is homogeneous). The resulting solution is concentrated on rotavapor at 30° C. under reduced pressure until complete ethanol removal (with completeness being ensured by weighing). The resulting hydrogel is doped by addition of a solution of IrCl₃ (from 0.005 to 0.1 equiv) dissolved in distilled and deionized water (for better solubility) and 60 mL acetonitrile. To this mixture is added NaOH(aq) 1M (from 0.026 to 0.053 equiv) to favor the gelation process. The resulting homogeneous and clear gel is left open to dry at ambient temperature for about 4 days. The xerogel thereby obtained is then reduced at room temperature with a solution of sodium borohydride in THF (Ir:NaBH₄=1:12 molar ratio; 0.9 M), washed with H₂O and THF and left open to dry at room temperature. The resulting catalysts are reported in Table 35 as entries Si—Ir-1 and Si—Ir-2.

TABLE 35

| | | | Pore | Pores | MTES:IrCl₃:H⁺: |
|---|---|---|---|---|---|
| | Loading | Surface | Size | Volume | H₂Oₜₒₜₐₗ:NaOH |
| Entry | (mmol/g) | (m²/g) | (Å) | (cm³/g) | (equiv) |
| Si—Ir-1 | 0.05 | 543 | 43 | 0.42 | 1:0.005:0.003:16.06: |
| | | | | | 0.026 |
| Si—Ir-2 | 0.10 | 551 | 68 | 1.34 | 1:0.01:0.003:21.13: |
| | | | | | 0.053 |

### Example 33

### Iridium-Containing Organosilica Catalytic Reactions—Reduction of a Double Bond

The substrate (0.5 mmol, 1 equiv) and the Si—Ir catalyst prepared in example 32 in ethanol (5 mL) are stirred at room temperature under hydrogen atmosphere (1 atm.). After completion of the reaction, the catalyst is filtered off and washed with ethanol. Conversion to the desired product is determined by GC/MS analysis with respect to the substrate. The results are summarized in Table 36.

TABLE 36

| | | % Mol | Time | | ^{b}Conversion |
|---|---|---|---|---|---|
| Entry | Substrate | ^{a}catalyst | (h) | Product | (%) |
| 36-1 | 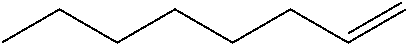 | 5 mol % Si—Ir-1 | 17 | 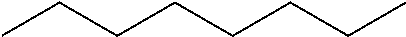 | 100 |
| 36-2 | 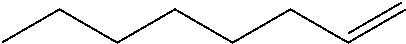 | 5 mol % Si—Ir-2 | 17 | 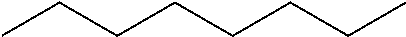 | 100 |

^{a}Mol % catalyst identified in Table 35 and used in reaction.
^{b}The conversion with respect to the substrate is determined by GC/MS analysis

### Example 34

### ²⁹Si Solid NMR

Solid state NMR spectra are recorded on a Bruker Avance spectrometer (Milton, ON) at a Silicon frequency of 79.5 MHz. Samples are spun at 8 kHz at magic angle at room temperature in a 4 mm ZrO rotor. A Hahn echo sequence synchronized with the spinning speed is used while applying a TPPM15 composite pulse decoupling during acquisition. 2400 acquisitions are recorded with a recycling delay of 30 seconds. The catalysts analyzed correspond to those of examples 1, 5 and 17. The results are shown in Table 37.

TABLE 37

| | T₁ | T₂ | T₃ | T₁:T₂:T₃ |
|---|---|---|---|---|
| Catalyst | ppm | ppm | ppm | (%) |
| Literature¹ | −46 | −56 | −66 | |
| Si-0-A | 0 | −55.58 | −66.38 | 0:10:90 |
| Si—Pd-1 | 0 | −55.64 | −65.18 | 0:10:90 |
| Si—Pd-2 | 0 | −55.78 | −65.32 | 0:10:90 |
| Si—Pd-3 | 0 | −55.58 | −65.27 | 0:10:90 |
| Si—Pd-4 | 0 | −54.76 | −65.06 | 0:10:90 |
| Si—Pt-3 | 0 | −55.42 | −66.94 | 0:5:95 |
| Si—Cu-6 | 0 | −55.22 | −66.28 | 0:5:95 |

¹Q. Cai, Z.-S. Luo, W.-Q. Pang, Y.-W. Fan, X.-H. Chan, and F. Z. Cui, Chemistry of Materials, 2001, 13, p. 258-263

### Example 35

### X-Ray Diffraction Analysis (XRD)

The crystallinity of the active phase in the catalysts is determined using X-ray powder diffraction (XRD) techniques performed on a Siemens D-5000 X-ray diffractometer. The catalysts are subjected to a monochromatic Cu Kα radiation source (λ=1.5418) and spectra are recorded in the 2θ range of 10-90° at a scan speed of 1°/min and a step scan of 0.02°. The amorphous RSiO_{1/2}, SiO₂ adsorbent is confirmed by observing the characteristic wide diffractogram displayed by this material, while the crystalline lattice of the O-M reference materials depicted a succession of sharp peaks. The mean particle size are estimated by analyzing the broadening of the (111) reflection and calculated by the Scherrer equation (Scherrer formula: d=0.9λ/β cos θ, where λ is the wavelength of X-ray radiation, and β is the full-width at half maximum line width in radians). The results are presented in Table 38.

TABLE 38

| | |
|---|---|
| ^{b}Diffraction angle 2θ | Mean particle |

| Catalyst | 111 | 200 | 220 | 311 | size (nm) |
|---|---|---|---|---|---|
| ^{a}0-Pd | 40.12 | 46.66 | 68.12 | 82.10 | N.A. |
| Si—Pd-4 | 39.96 | 46.66 | 68.11 | 81.90 | 5.7 |
| ^{a}0-Pt | 39.76 | 46.24 | 67.46 | 81.29 | N.A. |
| Si—Pt-1 | 39.76 | 46.16 | 67.74 | 81.12 | 1.70 |
| Si—Pt-2 | 39.86 | 46.04 | 67.52 | 80.62 | 2.92 |
| Si—Pt-3 | 39.76 | 46.16 | 67.62 | 81.25 | 3.15 |
| ^{a}0-Ag | 38.12 | 44.28 | 64.43 | 77.48 | N.A. |
| Si—Ag-1 | 38.09 | 44.16 | 64.46 | 77.33 | 1.01 |
| ^{a}0-Cu | 43.29 | 50.43 | 74.13 | 89.93 | N.A. |
| Si—Cu-3 | 43.29 | 50.42 | 73.91 | | 0.5 |

^{a}The Powder Diffraction File of The International Centre for Diffraction Data is used to identified the diffractions peaks characteristic of crystalline M(0) with a face centered cubic (fcc) lattice identified 0-M (M: Pd, Pt, Ag, Cu).

### Example 36

### GC/MS Analysis

The conversion with respect to the substrate was determined by GC/MS analysis using a Perkin Elmer Clarus 600 Gas Chromatograph equipped with a Perkin Elmer Clarus 600C Mass Spectrometer.

GC Method: Column RTX-5 ms, 30M×0.25 mm×0.25 um; injection: 1 uL at Split mode (20:1); injector temperature: 280° C.; oven temperature: 50° C. hold for 4.5 minutes, ramp at 25° C./min until reach 300° C. and hold for 0.5 minute (total runtime=15.00 minutes); transfer line temperature: 280° C.; carrier: Helium at 1 mL/minute. MS Method: Ionisation Mode: EI+; scan mass: m/z between 2 and 600; scan time: between 0 and 15 minutes.

While the invention has been described in connection with specific embodiments thereof, it is understood that it is capable of further modifications and that this application is intended to cover any variation, use, or adaptation of the invention following, in general, the principles of the invention and including such departures from the present disclosure that come within known, or customary practice within the art to which the invention pertains and as may be applied to the essential features hereinbefore set forth, and as follows in the scope of the appended claims.

1. A metal-containing organosilica catalyst comprising one or more metal catalyst or a precursor thereof and silica, wherein said metal catalyst or a precursor thereof is incorporated into a network of Si—O—Si bonds of said silica.

2. The metal-containing organosilica catalyst of claim 1, wherein the metal in said metal-containing organosilica catalyst is a transition metal or a metal of columns IIIa to VIa of the periodic table.

3. A process for preparing a metal-containing organosilica catalyst, comprising,
i) mixing a silicon source with an hydrolytic solvent;
ii) adding one or more metal catalyst or a precursor thereof;
iii) treating the mixture of step ii) with a condensation catalyst and
iv) optionally treating the mixture resulting from step iii) with one or more reducing agent such as to provide the required oxidation level to the metal catalyst.

4. The process of claim 3 wherein said step iv) is comprising treating the mixture resulting from step iii) with one or more reducing agent.

5. The process of claim 4 wherein said reducing agent includes hydride-based reducing agents.

6. The process of claim 3 wherein said step ii) is adding one or more precursor of said metal catalyst.

7. The process of claim 6 wherein said metal precursor is a metal complex, a metal salt or their corresponding anhydrous or solvated forms.

8. The process of claim 3 wherein said silicon source is a compound of formula R₄₋ₓSi(L)ₓ wherein R is an alkyl, an aryl or an alkyl-aryl such as a benzyl, L is independently CI, Br, I or OR′ wherein R′ is an alkyl or benzyl and x is an integer of 1 to 4.

9. A process of conducting a metal-catalyzed reaction, the process comprising using a metal-containing organosilica catalyst as defined in claim 1 for conducting the metal-catalyzed reaction.

10. A method for conducting a catalytic reaction comprising providing a metal-containing organosilica catalyst as described in claim 1, providing at least one reactant capable of entering into said catalytic reaction, allowing said at least one reactant to diffuse and adsorb onto the metal of said metal-containing organosilica catalyst and allowing a product resulting from said catalytic reaction to desorb from the metal and diffuse away from the solid surface to regenerate a catalytic site onto the metal of said metal-containing organosilica catalyst.

11. The process of claim 4 wherein said step ii) is adding one or more precursor of said metal catalyst.

12. The process of claim 5 wherein said step ii) is adding one or more precursor of said metal catalyst.

13. The process of claim 4 wherein said silicon source is a compound of formula R₄₋ₓ(Si(L)ₓ wherein R is an alkyl, an aryl or an alkyl-aryl such as a benzyl, L is independently CI, Br, I or OR′ wherein R′ is an alkyl or benzyl and x is an integer of 1 to 4.

14. The process of claim 5 wherein said silicon source is a compound of formula R₄₋ₓSi(L)ₓ wherein R is an alkyl, an aryl or an alkyl-aryl such as a benzyl, L is independently Cl, Br, I or OR′ wherein R′ is an alkyl or benzyl and x is an integer of 1 to 4.

15. The process of claim 6 wherein said silicon source is a compound of formula R₄₋ₓSi(L)ₓ wherein R is an alkyl, an aryl or an alkyl-aryl such as a benzyl, L is independently Cl, Br, I or OR′ wherein R′ is an alkyl or benzyl and x is an integer of 1 to 4.

16. The process of claim 7 wherein said silicon source is a compound of formula R₄₋ₓSi(L)ₓ (wherein R is an alkyl, an aryl or an alkyl-aryl such as a benzyl, L is independently Cl, Br, I or OR′ wherein R′ is an alkyl or benzyl and x is an integer of 1 to 4.
